(19) United States
(12) Patent Application Publication
(10) Pub. No.: US 2018/0248175 A1
(43) Pub. Date: Aug. 30, 2018

(54) MIXED ALLOTROPE PARTICULATE CARBON FILMS AND CARBON FIBER MATS

(71) Applicant: Lyten, Inc., Sunnyvale, CA (US)

(72) Inventors: Hossein-Ali Ghezelbash, Santa Clara, CA (US); Clayton Gibbs, Santa Clara, CA (US); Prashanth Jampani Hanumantha, Mountain View, CA (US); Shreeyukta Singh, Sunnyvale, CA (US); David Tanner, San Jose, CA (US)

(73) Assignee: Lyten, Inc., Sunnyvale, CA (US)

(21) Appl. No.: 15/905,157

(22) Filed: Feb. 26, 2018

Related U.S. Application Data
(60) Provisional application No. 62/464,489, filed on Feb. 28, 2017.

(51) Int. Cl. H01M 4/36; H01M 4/38; H01M 4/587; H01M 10/0525

(52) U.S. Cl. CPC H01M 4/364; H01M 4/386; H01M 2004/021; H01M 10/0525; H01M 4/587

(57) ABSTRACT

Mixed allotrope particulate carbon films and carbon fiber mats including partially ordered carbon materials or fibers, a plurality of highly ordered carbon aggregates, and a plurality of active materials particles are disclosed. In various embodiments, the highly ordered carbon aggregates comprise graphene with no seed particles. In various embodiments, the active materials particles comprise silicon.

### RELATED APPLICATIONS

The application claims the benefit of U.S. Provisional Patent Application No. 62/464,489, filed on Feb. 28, 2017, and entitled “Battery and Energy Storage”; which is hereby incorporated by reference for all purposes.

### BACKGROUND

Carbon fibers (e.g., amorphous carbon fibers, or graphite fibers) are fibers that are typically about 1-10 microns in diameter and composed mainly of carbon atoms. Carbon fibers typically have high stiffness, high tensile strength, low weight, high chemical resistance, high temperature tolerance, low thermal expansion, and moderate thermal conductivity and electrical conductivity. These properties have made carbon fiber-containing composite materials popular in aerospace, civil engineering, military, and competition sports equipment. However, they are relatively expensive when compared with similar fibers, such as glass fibers or plastic fibers.

Carbon fibers with moderate electrical conductivity can be formed into a mat, which is either free-standing or deposited on a substrate. However, the conductivity of conventional carbon fibers is not high enough to use in many electronic and energy storage applications, such as supercapacitors, and battery electrodes. Typically, other types of substrates, such as metallic foils or meshes are used in these applications. These substrates are coated or impregnated with one or more active materials and function as a current collector, bringing electrical current from the active material to a device terminal. For example, in typical secondary Li/S batteries, a metallic foil is coated with a slurry containing sulfur active material to form the cathode of the battery.

### SUMMARY

In some embodiments, a mixed allotrope particulate carbon film comprises a partially ordered carbon material comprising a carbonized polymer material; a plurality of highly ordered carbon aggregates; and a plurality of active materials particles. In some embodiments, the plurality of highly ordered carbon aggregates comprises multi-walled spherical fullerenes. In some embodiments, a Raman spectrum of the partially ordered carbon material, using 532 nm incident light, comprises: a D-mode peak; a G-mode peak; and a D/G intensity ratio from 1.2 to 1.7; and a shallow valley between the D-mode peak and G-mode peak. In some embodiments, a Raman spectrum of the highly ordered carbon aggregates comprising multi-walled spherical fullerenes, using 532 nm incident light, comprises: a D-mode peak and a G-mode peak, and the D/G intensity ratio is from 0.9 to 1.1. In some embodiments, the active materials particles comprise silicon.

In some embodiments, a mixed allotrope carbon fiber mat comprises partially ordered carbon fibers comprising carbonized polymer fibers, a plurality of highly ordered carbon aggregates, and a plurality of active materials particles. In some embodiments, the plurality of highly ordered carbon aggregates comprises a plurality of carbon nanoparticles, each carbon nanoparticle comprising graphene with up to 15 layers, with no seed particles. In some embodiments, a ratio of carbon to other elements, except hydrogen, in the highly ordered carbon aggregates is greater than 99%. In some embodiments, a median size of the highly ordered carbon aggregates is from 1 to 50 microns. In some embodiments, a surface area of the highly ordered carbon aggregates is from 50 m²/g to 2000 m²/g, when measured via a Brunauer-Emmett-Teller (BET) method with nitrogen as the adsorbate. In some embodiments, the highly ordered carbon aggregates, when compressed, have an electrical conductivity from 500 S/m to 20,000 S/m. In some embodiments, a Raman spectrum of the partially ordered carbon fibers, using 532 nm incident light, comprises: a D-mode peak; a G-mode peak; and a D/G intensity ratio from 1.2 to 1.7; and a shallow valley between the D-mode peak and G-mode peak. In some embodiments, a Raman spectrum of the highly ordered carbon aggregates comprising graphene, using 532 nm incident light, comprises: a 2D-mode peak; a G-mode peak; and a 2D/G intensity ratio greater than 0.5. In some embodiments, the active materials particles comprise silicon.

Lithium-ion secondary batteries containing the mixed allotrope particulate carbon films and the mixed allotrope carbon fiber mats are also described.

### BRIEF DESCRIPTION OF THE DRAWINGS

FIGS. 1A-1D are schematics of carbon allotropes from the prior art.

FIG. 1E is a schematic of idealized connected multi-walled spherical fullerenes, in accordance with some embodiments.

FIG. 2 is a flowchart of methods for generating mixed allotrope carbon fiber mats, in accordance with some embodiments.

FIG. 3A shows Raman spectra from a PAN fiber mat before carbonization and carbon fiber mats after different carbonization processes, in accordance with some embodiments.

FIG. 3B shows scanning electron microscope (SEM) images of carbon fiber mats, with and without Si active materials particles, in accordance with some embodiments.

FIG. 4 shows Raman spectra from carbon fiber mats with and without Si active materials particles, and processed with different carbonization conditions, in accordance with some embodiments.

FIG. 5 shows Raman spectra from carbon fiber mats with Si active materials particles, and processed with different electrospinning conditions, in accordance with some embodiments.

FIG. 6 shows SEM images of carbon fiber mats with different concentrations of Si active materials particles, in accordance with some embodiments.

FIG. 7 shows Raman spectra from carbon fiber mats with different concentrations of Si active materials particles, in accordance with some embodiments.

FIG. 8 shows SEM images of carbon fiber mats with carbon particles and Si active materials particles, in accordance with some embodiments.

FIG. 9 shows Raman spectra from carbon fiber mats with Si active materials particles, and with and without carbon particles, in accordance with some embodiments.

FIG. 10 shows a Raman spectrum from carbon particles, in accordance with some embodiments.

FIGS. 11A and 11B show histograms of peak ratios from a 100-point Raman map of carbon particles, in accordance with some embodiments.

FIG. 12 shows SEM images of carbon particles, in accordance with some embodiments.

FIG. 13 shows SEM images of polymer fiber mats with active materials, in accordance with some embodiments.

FIG. 14 shows SEM images of intrinsically conductive polymers with and without Si active materials particles, in accordance with some embodiments.

### DETAILED DESCRIPTION

In the present disclosure, porous carbon-based materials such as carbon fiber mats and alternative embodiments with improved properties and structures are described. Methods for producing the improved carbon fiber mats and alternative embodiments are also described. In some embodiments, porous carbon-based materials are mixed allotrope materials that contain a partially ordered carbon material and a highly ordered carbon material. The term “mixed allotrope” as used herein describes a material that contains more than one allotrope (e.g., two different allotropes of carbon).

In some embodiments, mixed allotrope porous carbon-based materials contain electrically conductive carbon fiber mats that incorporate carbon fibers with more than one allotrope of carbon (e.g., a partially ordered carbon and graphene, or amorphous carbon and graphene). In some embodiments, the carbon fiber comprises a matrix of a first carbon allotrope (e.g., amorphous or partially ordered carbon), and a second carbon allotrope that is highly ordered (e.g., graphene or fullerenes). In some embodiments, the highly ordered second allotrope of carbon contains unique carbon materials, such as improved graphene (e.g., with a high degree of atomic order, high surface area, high purity and/or high electrical conductivity) and improved fullerenes and/or connected fullerenes (e.g., with a high degree of atomic order, high surface area, high purity and/or high electrical conductivity) over conventional carbon materials. In some embodiments, ordered or highly ordered carbon allotropes are carbon materials with a specific crystal structure (e.g., a crystal structure with hexagonally arranged carbon atoms in the case of graphene), and a low concentration of atomic defects (e.g., as measured by Raman spectroscopy).

In some embodiments, the porous carbon-based materials, such as the electrically conductive carbon fiber mats described herein, incorporate carbon materials (e.g., fibers) with embedded particles of active material (e.g., silicon particles). In some embodiments, the porous carbon-based materials incorporate carbon materials with more than one allotrope of carbon and embedded particles of active material (e.g., amorphous carbon and graphene fibers with embedded silicon particles). In different embodiments, active materials can have different functionalities, including but not limited to being capable of reversible intercalation or alloying (e.g., for active materials in battery electrodes), promoting or inhibiting chemical reactions, modifying the mechanical properties of the porous carbon-based materials, and/or chemically bonding to different species within the porous carbon-based materials. Some examples of active materials are silicon, sulfur, LiₓS_{y}, V₂O₅, TiO₂, or other elemental or oxide materials used in battery electrodes. Examples of supportive polymers or additives are Nafion (a sulfonated tetrafluoroethylene based fluoropolymer-copolymer), silica, fumed silica, TiO₂, ZrO₂, and other oxides.

In the present disclosure, several alternative embodiments of porous carbon-based materials are also described, including electrically conductive carbon fiber mats containing electrically conductive polymers, carbon porous films containing carbon particles and polymer binders, and polymer fiber mats that are electrically insulating and ionically conductive (e.g., for use in a separator layer of a secondary battery).

The porous carbon-based materials described herein, such as the carbon fiber mats, and alternative embodiments described (e.g., polymer fiber mats, carbon particulate films formed from slurries including polymer binders, intrinsically conductive polymer fiber mats, etc.), can be used in a variety of applications including in improved secondary batteries (e.g., in current collectors, cathodes, anodes, separators, etc.), improved PEM fuel cells (e.g., in backing layers and micro-porous layers (MPLs)), and improved supercapacitors (e.g., as porous electrodes).

The present porous carbon-based materials, including the carbon fiber mats and alternative embodiments described, provide unique properties compared to conventional carbon fiber mats, such as higher electrical conductivity and increased porosity. The increased porosity can enable improved performance characteristics by, for example, altering the mobility of molecules and ions during chemical reactions.

Carbon Fiber Mats

In some embodiments, a polymer base material is spun into fibers, and the fibers are subsequently annealed to carbonize the polymer and form a carbon fiber mat. In the present disclosure, the terms “carbonize” and “carbonization” refer to the conversion of an organic substance (e.g., a polymer fiber) into carbon or a carbon-containing material (e.g., through pyrolysis or destructive distillation). Some examples of polymer base materials are polyacrylnitrile (PAN), poly(vinylidene fluoride-hexafluoropropylene) (PVDF-HFP), polythiophene, poly-3-hexyl-thiophene (P3HT), P3HT-PEO (polymers of ethylene oxide) co-polymers, polyvinyl alcohol (PVA), polyacrylic acid (PAA), and mixtures thereof. In some embodiments, particles (e.g., ordered carbon particles, active materials particles) are mixed into the polymer base material and then spun into fibers and carbonized to create a carbon fiber mat containing carbon fibers with the particles embedded therein.

In some embodiments, after carbonization of the spun fibers, the carbon allotropes within the fibers are partially ordered. The species of carbon allotropes present, and their degree of order can be measured by Raman spectroscopy. The main peaks in the Raman spectra for graphite and graphene are the G-mode, the D-mode and the 2D-mode. The G-mode peak has a wave number of approximately 1580 cm⁻¹, and is attributed to the vibration of carbon atoms in sp²-hybridized carbon networks. The D-mode peak has a wave number of approximately 1350 cm⁻¹, and can be related to the breathing of hexagonal carbon rings with defects. The 2D-mode peak is a second-order overtone of the D-mode and has a wave number of approximately 2690 cm⁻¹.

In some embodiments, the partially ordered carbon allotropes (e.g., within carbonized polymer material) have a Raman spectrum (using 532 nm incident light) with a 2D-mode peak, a D-mode peak and a G-mode peak, and the ratio of the intensity of the D-mode peak to the G-mode peak (i.e., the D/G intensity ratio) is greater than 0.5, or is from 1.2 to 1.7, or is from 1 to 2, or is from 0.5 to 2. In some embodiments, the Raman spectrum also has a low intensity 2D-mode peak. In some embodiments, the 2D-mode peak has an intensity less than approximately 30% of the G-mode peak intensity, or less than 20% of the G-mode peak intensity, or less than 10% of the G-mode peak intensity. In some embodiments, the Raman spectrum has a D-mode peak and G-mode peak with a shallow valley between them. In some embodiments, the minimum intensity of the shallow valley between the D-mode peak and the G-mode peak is greater than approximately 40% of the G-mode peak intensity, or greater than approximately 50% of the G-mode peak intensity, or greater than approximately 60% of the G-mode peak intensity. This is in contrast with more ordered carbon allotropes, which typically have Raman spectra with deep valleys between the D-mode peak and G-mode. For example, in more ordered carbon allotropes, the minimum intensity of the deep valley between the D-mode peak and the G-mode peak can be less than approximately 40% of the G-mode peak intensity, or less than approximately 30% of the G-mode peak intensity.

In some embodiments, the polymer base material, with or without particles added to the base material, is spun into fibers via wet spinning or electrospinning. Electrospun fibers can create fibers with smaller diameters than wet spun fibers, and therefore create a fiber mat with higher surface area and smaller pore sizes. In some embodiments, the spun fibers (e.g., electrospun fibers) are formed on a substrate. In some cases, the carbon fiber mats are spun onto insulating substrates (e.g., cellulose-based papers), or electrically conductive substrates (e.g., metal foils or meshes). Electrospinning systems typically include a needle through which the electrospinning solution flows, and a collector upon which the electrospun fibers are deposited. A bias voltage is applied between the needle and the collector to facilitate the electrospinning. The voltage between the needle and the collector, the flow rate of the electrospinning solution and the needle-to-collector distance can be important variables in the electrospinning processes. In some embodiments, the voltage between the needle and the collector is from 1 kV to 20 kV, or from 5 kV to 20 kV, or approximately 10 kV. In some embodiments, the flow rate of the electrospinning solution is from 0.1 mL/hr to 5 mL/hr, or from 0.5 to 2 mL/hr, or approximately 1 mL/hr, or approximately 1.5 mL/hr. In some embodiments, the needle-to-collector distance is from 1″ to 10″, or from 2″ to 6″, or is approximately 2″, or is approximately 6″. Additionally, the electrospinning solution viscosity and the concentration of fiber-forming materials (e.g., polymeric materials) and solvents can also be important parameters. In some embodiments, the concentration of fiber-forming materials is from 0.5 wt % to 5 wt %, or from 1 wt % to 3 wt % in a solvent. In some embodiments, the electrospinning enables smaller fiber diameters than conventional wet spinning approaches to fabricating carbon fiber mats, which in turn enable the present carbon fiber mats to have improved porosity.

In some embodiments, carbon particles are mixed into the polymer base material and then spun into fibers and carbonized to create a carbon fiber mat containing carbon fibers with the carbon particles embedded therein. In some embodiments, the carbon particles contain carbon allotropes that are the same or different than the allotropes formed by the carbonized base polymer. In some embodiments, the allotropes in the carbon particles are ordered, or highly ordered. Carbon particles containing carbon allotropes that have improved properties compared to conventional carbon particles are discussed further below. In some embodiments, the improved properties of the carbon materials, such as improved surface area and electrical conductivity compared to conventional carbon particles, enable improved properties of the carbon fiber mat, such as improved porosity and electrical conductivity compared to conventional carbon fiber mats.

In some embodiments, active materials particles are mixed into the polymer base material and then spun into fibers and carbonized to create a carbon fiber mat containing carbon fibers with the active materials particles embedded therein. In some embodiments, the active materials particles are mixtures of more than one active material. In some cases, the average length-scale of the different materials components in the mixture is less than 100 nm, or less than 10 nm. The mixtures can be mixtures of aggregates particles of different materials, or can be a plurality of particles of one material embedded in a matrix of a second material. Therefore, in some cases, the “average length-scale” can be defined by following a straight line through the mixture, and determining the average length of uninterrupted line segments occupied by each material. For example, active materials particles can contain 10-100 nm average length-scale mixtures of silicon and carbon, or silicon dioxide and carbon, or LiₓS_{y} and carbon. In some embodiments, active materials particles are embedded into the carbon fiber mats, and the active materials particles have diameters below 1 micron, or below 100 nm, or from 10 nm to 2 microns, or from 10 nm to 1 micron, or from 10 nm to 100 nm, or from 30 nm to 50 nm. In some embodiments, carbon particles and active materials particles are mixed into the polymer base material and then spun into fibers and carbonized to create a carbon fiber mat containing carbon fibers with the carbon particles and the active materials particles embedded therein. In some embodiments, carbon fiber mats are spun from solutions containing ratios of carbon and/or active materials particles to base polymer from 1:5 to 5:1, or from 1:1 to 1:3. In some embodiments, the mass fraction of active materials particles in the carbon fiber mats is from 5 wt % to 50 wt %, or from 10 wt % to 40 wt %, or from 20 wt % to 40 wt %. In some embodiments, the embedding of the active materials into the carbon fibers of the carbon fiber mat enables improved properties over conventional approaches in which active materials are deposited within the pores of a pre-existing substrate (e.g., a metal mesh). For example, the present carbon fiber mats with embedded active materials particles enable improved distributions of active materials particles and/or higher concentrations of active materials that are well dispersed within the conductive carbon scaffold provided by the fibers compared to conventional approaches.

In some embodiments, carbon fiber mats contain fibers with average diameters from 100 nm to 10 microns, or from 100 nm to 5 microns, or from 100 nm to 2 microns, or less than 10 microns, or less than 5 microns, or less than 2 microns. In some embodiments, carbon fiber mats have surface areas from 100 m²/g to 3000 m²/g, or from 500 m²/g to 3000 m²/g, or from 500 m²/g to 2000 m²/g, or from 1000 m²/g to 2000 m²/g. In some embodiments, carbon fiber mats have average pore volumes from 0.1 cc/g to 5 cc/g, or from 0.2 cc/g to 2 cc/g, or from 0.5 cc/g to 1.5 cc/g.

The present carbon fiber mats provide improved properties compared to conventional carbon fiber mats. In some cases, the materials, such as the improved carbon particles described above, enables the carbon fiber mats with improved properties. In other cases, the processing, such as electrospinning compared to wet spinning, enables the carbon fiber mats with improved properties. For example, the small diameter fibers produced via electrospinning provide increased porosity compared to conventional carbon fiber mats. The increased porosity can be beneficial for carbon fiber mats used in Li/S battery cathodes for example, by limiting the mobility of the generated polysulfide molecules within the cathode. Furthermore, the incorporation of conductive highly ordered carbon aggregates provides higher electrical conductivity than conventional carbon fiber mats. Furthermore, the direct incorporation of active materials within the carbon fiber mats can improve certain device performance (e.g., by creating a high concentration of active materials particles within a conductive matrix for battery electrodes), and simplify device processing by eliminating process steps that would be otherwise required to add the active material to a fiber mat.

Carbon Particles Containing Ordered Carbon Allotropes

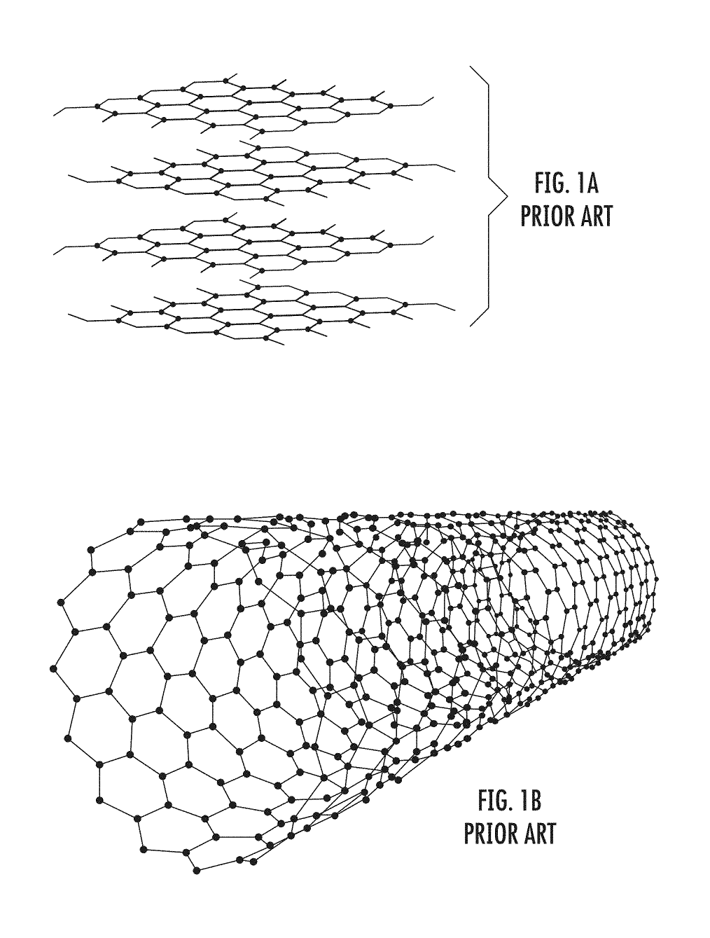

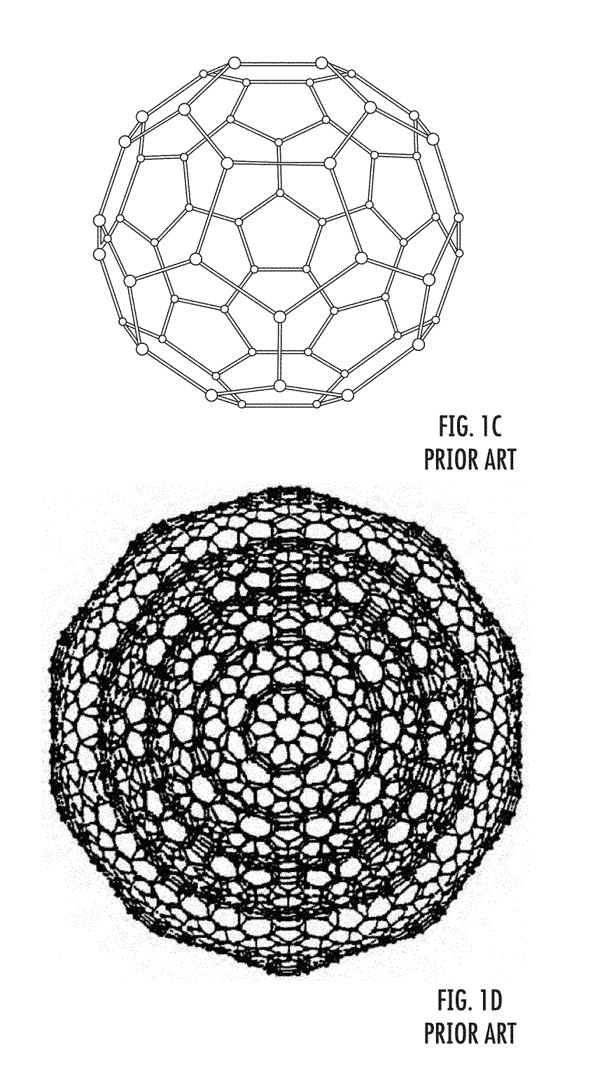

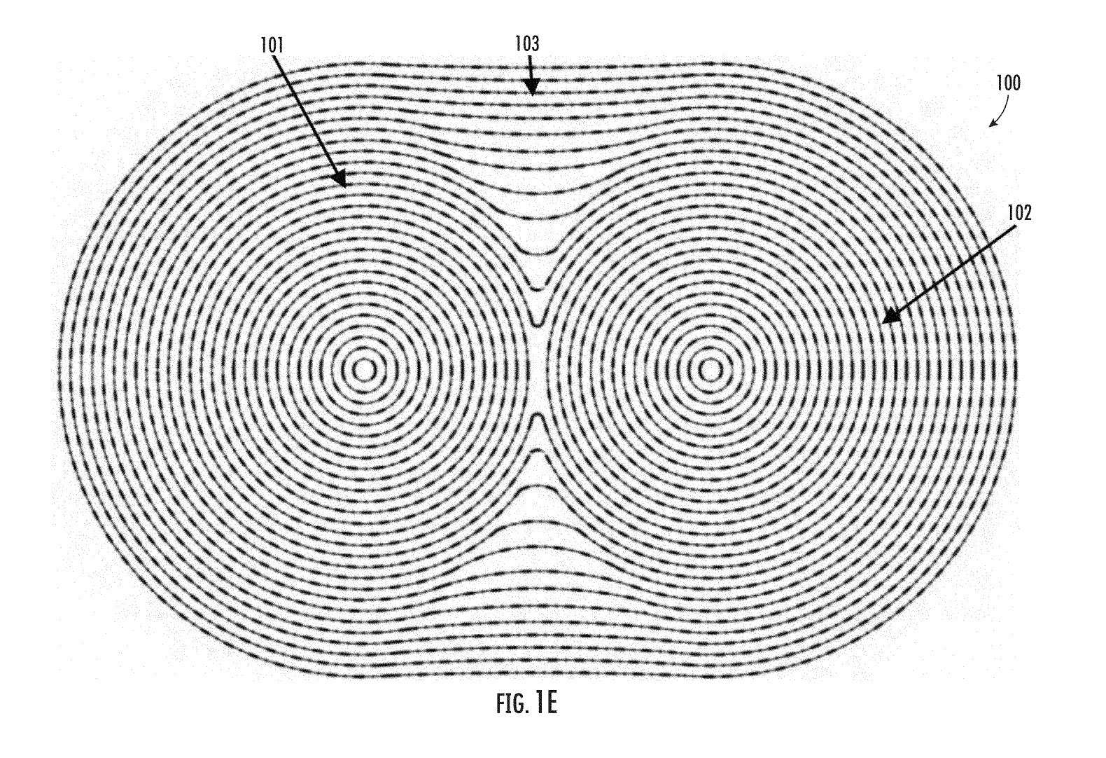

FIGS. 1A-1E show some examples of carbon particles containing ordered carbon allotropes that can be incorporated into the carbon fiber mats described herein. FIG. 1A shows a schematic of graphite, where carbon forms multiple layers of a two-dimensional, atomic-scale, hexagonal lattice in which one atom forms each vertex. Graphite is made of single layers of graphene. FIG. 1B shows a schematic of a carbon nanotube, where carbon atoms form a hexagonal lattice that is curved into a cylinder. Carbon nanotubes can also be referred to as cylindrical fullerenes. FIG. 1C shows a schematic of a C60 buckminsterfullerene, where a single layer of a hexagonal lattice of carbon atoms forms a sphere. Other spherical fullerenes exist that contain single layers of hexagonal lattices of carbon atoms, and can contain 60 atoms, 70 atoms, or more than 70 atoms. FIG. 1D shows a schematic of a carbon nano-onion from U.S. Pat. No. 6,599,492, which contains multiple concentric layers of spherical fullerenes. In some embodiments, the ordered carbon allotropes described herein are characterized by a well-ordered structure with high purity as illustrated by an idealized carbon nanoparticle 100 shown in FIG. 1E. The carbon allotrope in FIG. 1E contains two connected multi-walled spherical fullerenes (MWSFs) 101 and 102 with layers of graphene 103 coating the connected MWSFs 101 and 102.

In the present disclosure, the term “graphene” refers to an allotrope of carbon in the form of one or more two-dimensional, atomic-scale, hexagonal lattice layers in which one atom forms each vertex. The carbon atoms in graphene are sp2-bonded. Additionally, graphene has a Raman spectrum with three main peaks: a G-mode at approximately 1580 cm⁻¹, a D-mode at approximately 1350 cm⁻¹, and a 2D-mode peak at approximately 2690 cm⁻¹ (when using a 532 nm excitation laser). In the present disclosure, a single layer of graphene is a single sheet of hexagonally arranged (i.e., sp2-bonded) carbon atoms. It is known that the ratio of the intensity of the 2D-mode peak to the G-mode peak (i.e., the 2D/G intensity ratio) is related to the number of layers in the graphene. A higher 2D/G intensity ratio corresponds to fewer layers in multilayer graphene materials. In different embodiments of the present disclosure, graphene contains fewer than 15 layers of carbon atoms, or fewer than 10 layers of carbon atoms, or fewer than 7 layers of carbon atoms, or fewer than 5 layers of carbon atoms, or fewer than 3 layers of carbon atoms, or contains a single layer of carbon atoms, or contains from 1 to 10 layers of carbon atoms, or contains from 1 to 7 layers of carbon atoms, or contains from 1 to 5 layers of carbon atoms. In some embodiments, few layer graphene (FLG) contains from 2 to 7 layers of carbon atoms. In some embodiments, many layer graphene (MLG) contains from 7 to 15 layers of carbon atoms.

In the present disclosure, the term “graphite” refers to an allotrope of carbon in the form of a plurality of two-dimensional, atomic-scale, hexagonal lattice layers in which one atom forms each vertex. The carbon atoms in graphite are sp2-bonded. Additionally, graphite has a Raman spectrum with two main peaks: a G-mode at approximately 1580 cm⁻¹ and a D-mode at approximately 1350 cm⁻¹ (when using a 532 nm excitation laser). Similar to graphene, graphite contains layers of hexagonally arranged (i.e., sp2-bonded) carbon atoms. In different embodiments of the present disclosure, graphite can contain greater than 15 layers of carbon atoms, or greater than 10 layers of carbon atoms, or greater than 7 layers of carbon atoms, or greater than 5 layers of carbon atoms, or greater than 3 layers of carbon atoms.

In the present disclosure, the term “fullerene” refers to a molecule of carbon in the form of a hollow sphere, ellipsoid, tube, or other shapes. Spherical fullerenes can also be referred to as Buckminsterfullerenes, or buckyballs. Cylindrical fullerenes can also be referred to as carbon nanotubes. Fullerenes are similar in structure to graphite, which is composed of stacked graphene sheets of linked hexagonal rings. Fullerenes may also contain pentagonal (or sometimes heptagonal) rings.

In the present disclosure, the term “multi-walled fullerene” refers to fullerenes with multiple concentric layers. For example, multi-walled nanotubes (MWNTs) contain multiple rolled layers (concentric tubes) of graphene. Multi-walled spherical fullerenes (MWSFs) contain multiple concentric spheres of fullerenes.

In the present disclosure, the term “amorphous carbon” refers to a carbon allotrope that has minimal or no crystalline structure. One method for characterizing amorphous carbon is through the ratio of sp2 to sp3 hybridized bonds present in the material. The sp2 to sp3 ratios can be determined by comparing the relative intensities of various spectroscopic peaks (including EELS, XPS, and Raman spectroscopy) to those expected for carbon allotropes with sp2 or sp3 hybridization.

As described above, the carbon allotropes described herein (e.g., carbonized carbon fibers and carbon particles) can be characterized by Raman spectroscopy to determine the species of carbon allotropes present, and their degree of order.

In some embodiments, the graphite- and graphene-containing carbon materials have a Raman spectrum (using 532 nm incident light) with a 2D-mode peak and a G-mode peak, and the 2D/G intensity ratio is greater than 0.2, or greater than 0.5, or greater than 1.

Raman spectroscopy can also be used to characterize the structure of MWSFs. When using 532 nm incident light, the Raman G-mode is typically at 1582 cm−1 for planar graphite, but can be downshifted for MWSFs (e.g., to 1565-1580 cm−1). The D-mode is observed at approximately 1350 cm−1 in the Raman spectra of MWSFs. The ratio of the intensities of the D-mode peak to G-mode peak (i.e., the D/G intensity ratio) is related to the degree of order of the MWSFs, where a lower D/G intensity ratio indicates higher degree of order. A D/G intensity ratio near or below 1 indicates a relatively high degree of order, and a D/G intensity ratio greater than or equal to 1.2 indicates lower degree of order.

In some embodiments, the carbon materials containing the MWSFs have a Raman spectrum (using 532 nm incident light) with a D-mode peak and a G-mode peak, and the D/G intensity ratio is from 0.9 to 1.1, or less than about 1.2.

In some embodiments, the carbon materials containing amorphous carbon have a Raman spectrum (using 532 nm incident light) with a 2D-mode peak, a D-mode peak and a G-mode peak, and the D/G intensity ratio is greater than 0.5. In some embodiments, the Raman spectrum also has a low intensity 2D-mode peak. In some embodiments, the 2D-mode peak has an intensity less than approximately 30% of the G-mode mode peak intensity, or less than 20% of the G-mode peak intensity, or less than 10% of the G-mode peak intensity. In some embodiments, the Raman spectrum has a D-mode peak and G-mode peak with a shallow valley between them. In some embodiments, the minimum intensity of the shallow valley between the D-mode peak and the G-mode peak is greater than approximately 40% of the G-mode peak intensity, or greater than approximately 50% of the G-mode peak intensity, or greater than approximately 60% of the G-mode peak intensity.

In some embodiments, the carbon particles that can be incorporated into the carbon fiber mats and particulate carbon films described herein are described in U.S. patent application Ser. No. 15/711,620, entitled “Seedless Particles with Carbon Allotropes,” which is assigned to the same assignee as the present application, and is incorporated herein by reference as if fully set forth herein for all purposes. In some embodiments, the carbon particles that can be incorporated into the carbon fiber mats described herein contain graphene-based carbon materials that comprise a plurality of carbon aggregates, each carbon aggregate having a plurality of carbon nanoparticles, each carbon nanoparticle including graphene, with no seed (i.e., nucleation or core) particles. The graphene in the graphene-based carbon material can have up to 15 layers. A ratio of carbon to other elements, except hydrogen, in the carbon aggregates can be greater than 99%, or greater than 99.5%, or greater than 99.7%, or greater than 99.9%, or greater than 99.95%. A median size of the carbon aggregates can be from 1 to 50 microns, or from 1 micron to 50 microns, or from 2 microns to 20 microns, or from 5 microns to 40 microns, or from 5 microns to 30 microns, or from 10 microns to 30 microns, or from 10 microns to 25 microns, or from 10 microns to 20 microns. In some embodiments, the size distribution of the carbon aggregates has a 10^{th} percentile from 1 micron to 10 microns, or from 1 micron to 5 microns, or from 2 microns to 6 microns, or from 2 microns to 5 microns. A surface area of the carbon aggregates can be at least 50 m²/g, or from 50 to 3000 m²/g, or from 100 to 3000 m²/g, or from 50 to 2000 m²/g, or from 50 to 1500 m²/g, or from 50 to 1000 m²/g, or from 50 to 500 m²/g, or from 50 to 300 m²/g, when measured using a Brunauer-Emmett-Teller (BET) method with nitrogen as the adsorbate. The carbon aggregates, when compressed, can have an electrical conductivity greater than 500 S/m, or greater than 1000 S/m, or greater than 2000 S/m, or from 500 S/m to 20,000 S/m, or from 500 S/m to 10,000 S/m, or from 500 S/m to 5000 S/m, or from 500 S/m to 4000 S/m, or from 500 S/m to 3000 S/m, or from 2000 S/m to 5000 S/m, or from 2000 S/m to 4000 S/m, or from 1000 S/m to 5000 S/m, or from 1000 S/m to 3000 S/m.

In some embodiments, the carbon particles that can be incorporated into the carbon fiber mats and particulate carbon films described herein are produced using microwave plasma reactors and methods, such as any appropriate microwave reactor and/or method described in U.S. Pat. No. 9,812,295, entitled “Microwave Chemical Processing,” or in U.S. Pat. No. 9,767,992, entitled “Microwave Chemical Processing Reactor,” which are assigned to the same assignee as the present application, and are incorporated herein by reference as if fully set forth herein for all purposes.

In some embodiments, the carbon particles that can be incorporated into the carbon fiber mats and particulate carbon films described herein are described in U.S. Pat. No. 9,862,606 entitled “Carbon Allotropes,” which is assigned to the same assignee as the present application, and is incorporated herein by reference as if fully set forth herein for all purposes.

In some embodiments, the carbon particles that can be incorporated into the carbon fiber mats and particulate carbon films described herein are produced using thermal cracking apparatuses and methods, such as any appropriate thermal apparatus and/or method described in U.S. Pat. No. 9,862,602, entitled “Cracking of a Process Gas,” which is assigned to the same assignee as the present application, and is incorporated herein by reference as if fully set forth herein for all purposes.

In some embodiments, the carbon particles can be doped with sulfur. For example, in one approach large surface area carbon can be used to effectively mix sulfur with the carbon by triple ball milling the carbon (e.g., carbon particles containing MWSFs from a reactor) to about 1 micron average particle size. Hummer's method can then be used to oxidize the carbon, and/or a KOH with high temperature etch process can be performed. In some embodiments, graphene oxide sulfur-doped materials that have a large surface area (e.g., from 200 m²/g to 600 m²/g) can be produced. In other embodiments, sulfur nano-particles are mixed with carbon particles, and the mixture is then annealed to produce carbon particles that are doped with sulfur. In some embodiments, graphene oxide particles (which have oxygen bonds that mix well with water) and sulfur nano-particles are mixed with water.

Polymer Fiber Mat Alternative Embodiment

In some embodiments, a polymer base material is spun into fibers to form a polymer fiber mat. In these embodiments, no annealing is needed to carbonize the polymer. Some examples of polymer base materials are PAN, PVDF-HFP, polythiophene, P3HT, P3HT-PEO co-polymers, PVA, PAA, and mixtures thereof. In some embodiments, particles (e.g., ordered carbon particles, active materials particles) and/or other materials are mixed into the polymer base material and then spun into fibers to create a polymer fiber mat containing particles embedded therein and/or containing other materials. Some examples of other materials are Nafion, silica, fumed silica, TiO₂, ZrO₂, and other oxides. In some embodiments, these other materials provide structural stability, chemical binding, or inhibiting properties such as polysulfide trapping in Li/S batteries.

In some embodiments, the polymer base material, with or without particles and/or active materials added to the base material, is spun into fibers via wet spinning or electrospinning. In some embodiments, the spun fibers (e.g., electrospun fibers) are formed on a substrate. In some cases, the polymer fiber mats are spun onto insulating substrates (e.g., cellulose-based papers), or electrically conductive substrates (e.g., metal foils or meshes). In some embodiments, the voltage between the needle and the collector is from 1 kV to 30 kV, or from 5 kV to 30 kV, or approximately 10 kV. In some embodiments, the flow rate of the electrospinning solution is from 0.1 mL/hr to 5 mL/hr, or from 0.5 to 2 mL/hr, or approximately 1 mL/hr, or approximately 1.5 mL/hr. In some embodiments, the needle-to-collector distance is from 1″ to 10″, or from 2″ to 6″, or is approximately 2″, or is approximately 6″.

In some embodiments, polymer fiber mats contain fibers with average diameters from 100 nm to 10 microns, or from 100 nm to 5 microns, or from 100 nm to 2 microns, or less than 10 microns, or less than 5 microns, or less than 2 microns. In some embodiments, polymer fiber mats have surface areas from 100 m²/g to 3000 m²/g, or from 500 m²/g to 3000 m²/g, or from 500 m²/g to 2000 m²/g, or from 1000 m²/g to 2000 m²/g. In some embodiments, polymer fiber mats have average pore volumes from 0.1 cc/g to 5 cc/g, or from 0.2 cc/g to 2 cc/g, or from 0.5 cc/g to 1.5 cc/g. In some embodiments, polymer fiber mats have ionic conductivity from 0.001 to 0.01 S/m, or from 0.001 to 0.003 S/m.

The present polymer fiber mats provide improved properties compared to conventional electrically insulating polymer mats. In some cases, the materials, such as the improved carbon particles described above, enables the polymer fiber mats with improved properties. In other cases, the processing, such as electrospinning compared to wet spinning, enables the polymer fiber mats with improved properties. For example, the small diameter fibers produced via electrospinning provide increased porosity compared to conventional polymer fiber mats. The increased porosity can be beneficial for polymer fiber mats used in Li/S battery separators for example, by reducing the mobility of polysulfide molecules between the electrodes during operation.

Carbon Particle Slurry Alternative Embodiment

In some embodiments, carbon particles can be combined with a polymer binder and a solvent to form a slurry, and that slurry can be coated onto a substrate, dried and annealed to form a particulate carbon film. Some non-limiting examples of polymer binders are PAN, polyaniline (PANI), polyvinylpyrrolidone (PVP), and ethyl cellulose. The carbon particles in the slurry can contain one or more of the ordered carbon allotropes described herein. In some embodiments, more than one type of carbon particle can be mixed in the slurry. In some embodiments, graphene oxide particles can be mixed in the slurry. In some embodiments, active materials particles can be mixed with the carbon particles in the slurry. Some examples of active materials particles that can be incorporated into particulate carbon films are silicon, sulfur, LiₓS_{y}, V₂O₅, TiO₂, or other elemental or oxide materials in battery electrodes. In some embodiments, the active materials particles are mixtures of more than one active material, as described above. For example, active materials particles can contain 10-100 nm average length-scale mixtures of silicon and carbon, or silicon dioxide and carbon, or LiₓS_{y} and carbon. These particulate carbon films can be used in a variety of applications, including, for example, electrically conductive carbon paper. In some embodiments, the mass fraction of active materials particles in the particulate carbon films is from 5 wt % to 80 wt %, or from 5 wt % to 50 wt %, or from 10 wt % to 40 wt %, or from 20 wt % to 40 wt %.

In some embodiments, the particulate carbon films are annealed and the polymer binder material is carbonized into a partially ordered carbon-based material. In some embodiments, the particulate carbon films will have a Raman signature indicative of partially ordered carbon allotropes. Raman signatures of partially ordered carbon allotropes are described above. In some embodiments, the particulate carbon films are mixed allotrope particulate carbon films having a carbonized polymer binder partially ordered carbon allotrope and a carbon particle highly ordered carbon allotrope. In some cases, the Raman signature of the mixed allotrope particulate carbon films is dominated by the carbonized binder partially ordered carbon allotrope, and the Raman signature of the highly ordered carbon allotrope is not discernable. However, in such cases, the order of the highly ordered carbon allotrope can be observed, for example by TEM imaging or selective area Raman studies focused on the highly ordered carbon particles within the mixed allotrope particulate carbon films.

In some embodiments, the carbon particles can be pre-processed before incorporating into the slurry. For example, the carbon particles can be pre-processed using mechanical processing, such as ball milling, grinding, attrition milling, micro-fluidizing, jet milling, and other techniques to reduce the particle size without damaging the carbon allotropes contained within. Other examples of pre-processing include exfoliation processes such as shear mixing, chemical etching, oxidizing (e.g., Hummer method), thermal annealing, doping by adding elements during annealing (e.g., S, and N), steaming, filtering, and lypolizing, among others. Some other examples of pre-processing include sintering processes such as SPS (Spark Plasma Sintering, i.e., Direct Current Sintering), Microwave, and UV (Ultra-Violet), which can be conducted at high pressure and temperature in an inert gas. In some embodiments, multiple pre-processing methods can be used together or in series. In some embodiments, the pre-processing will produce functionalized carbon particles or aggregates.

In some embodiments, carbon particles (e.g., containing MWSFs) can be activated (e.g., to produce a good surface (pore size) to seed lithium ions during battery cycling). In some embodiments, this is achieved by ball milling the carbon particles from an average diameter of about 40 microns to an average diameter of about 1 micron, and steaming the surface of the carbon particles to expand the surface (e.g., the surface graphene layers). In an example embodiment, the steaming is performed at 180° C. in an autoclave for 12 hours. In another embodiment, the carbon particles are size-reduced by ball milling to an average diameter of about 1 micron, pre-annealed at 1000° C. in Argon (Ar), etched with potassium hydroxide (KOH), and steamed at 180° C. for 12 hours.

The present particulate carbon films provide improved properties compared to conventional particulate carbon films. In some cases, the materials, such as the improved carbon particles described above, enables the particulate carbon films with improved properties. For example, the incorporation of the improved highly ordered carbon aggregates with high electrical conductivity and high surface area provides higher electrical conductivity and higher porosity than conventional particulate carbon films. The improved electrical conductivity and porosity can be beneficial in numerous applications, including for example, within battery electrodes where electrical conductivity and porosity are important parameters.

Intrinsically Conductive Polymer Alternative Embodiment

In some embodiments, an intrinsically conductive polymer base material is spun into fibers to form an intrinsically conductive polymer fiber mat. In these embodiments, no annealing in needed to carbonize the polymer and form a carbon fiber mat. Some examples of intrinsically conductive polymer base materials are polythiophene, P3HT, P3HT-PEO co-polymers, and polyaniline. In some embodiments, particles (e.g., ordered carbon particles, active materials particles) and/or active materials are mixed into the intrinsically conductive polymer base material and then spun into fibers to create an intrinsically conductive polymer fiber mat containing intrinsically conductive polymer fibers with the particles embedded therein and/or containing the active materials. Some examples of active materials are silicon, sulfur, LiₓS_{y}, V₂O₅, TiO₂, or other elemental or oxide materials used in battery electrodes. In some embodiments, the active materials particles are mixtures of more than one active material, as described above. For example, active materials particles can contain 10-100 nm average length-scale mixtures of silicon and carbon, or silicon dioxide and carbon, or LiₓS_{y} and carbon. In some embodiments, the mass fraction of active materials particles in the intrinsically conductive polymer fiber mats is from 5 wt % to 80 wt %, or from 5 wt % to 50 wt %, or from 10 wt % to 40 wt %, or from 20 wt % to 40 wt %. In some embodiments, intrinsically conductive polymer fiber mats with no added carbon or active materials particles have electrical conductivities from 0.1 S/m to 10 S/m, or from 0.5 S/m to 5 S/m. In other embodiments, intrinsically conductive polymer fiber mats contain added carbon and/or active materials particles and have electrical conductivities from 10 S/m to 1000 S/m, or from 100 S/m to 1000 S/m.

In some embodiments, the intrinsically conductive polymer base material, with or without particles and/or active materials added to the base material, is spun into fibers via wet spinning or electrospinning. In some embodiments, the spun fibers (e.g., electrospun fibers) are formed on a substrate. In some cases, the intrinsically conductive polymer fiber mats are spun onto insulating substrates (e.g., cellulose-based papers), or electrically conductive substrates (e.g., metal foils). In some embodiments, the voltage between the needle and the collector is from 1 kV to 30 kV, or from 5 kV to 30 kV, or approximately 10 kV. In some embodiments, the flow rate of the electrospinning solution is from 0.1 mL/hr to 5 mL/hr, or from 0.5 to 2 mL/hr, or approximately 1 mL/hr, or approximately 1.5 mL/hr. In some embodiments, the needle-to-collector distance is from 1″ to 10″, or from 2″ to 6″, or is approximately 2″, or is approximately 6″.

In some embodiments, after spinning the intrinsically conductive polymer fiber mats can be post-processed. For example, the intrinsically conductive polymer fiber mats can be etched after spinning, for example, using alcohols (e.g., heated isopropanol (IPA)). In some embodiments, the intrinsically conductive polymer fiber mats can be doped (e.g., with I₂ in an oxidation process) after spinning. In some embodiments, multiple post-processes can be combined. For example, intrinsically conductive polymer fiber mats can be etched using IPA and then doped using I₂.

In some embodiments, intrinsically conductive polymer fiber mats contain fibers with average diameters from 100 nm to 10 microns, or from 100 nm to 5 microns, or from 100 nm to 2 microns, or less than 10 microns, or less than 5 microns, or less than 2 microns. In some embodiments, intrinsically conductive polymer fiber mats have surface areas from 100 m²/g to 3000 m²/g, or from 500 m²/g to 3000 m²/g, or from 500 m²/g to 2000 m²/g, or from 1000 m²/g to 2000 m²/g. In some embodiments, intrinsically conductive polymer fiber mats have average pore volumes from 0.1 cc/g to 5 cc/g, or from 0.2 cc/g to 2 cc/g, or from 0.5 cc/g to 1.5 cc/g. In some embodiments, intrinsically conductive polymer fiber mats are flexible, with elastic moduli from 0.1 GPa to 1 GPa, or from 0.5 to 5 GPa, or from 0.5 GPa to 2 GPa, or from 0.1 GPa to 1 GPa, or greater than 0.5 GPa.

The present intrinsically conductive polymer fiber mats provide unique properties compared to conventional polymer fiber mats. The intrinsically conductive polymers provide improved electrical conductivity compared with typically insulating polymers used in fibrous mats. Additionally, the incorporation of the highly ordered carbon aggregates with high electrical conductivity and high surface area provides even higher electrical conductivity and higher porosity than conventional particulate carbon films. Furthermore, the small diameter fibers produced via electrospinning also provide increased porosity compared to conventional polymer fiber mats. The improved electrical conductivity and porosity can be beneficial in numerous applications, including for example, within battery electrodes where electrical conductivity and porosity are important parameters. Furthermore, the direct incorporation of active materials within the intrinsically conductive polymer fiber mats can improve certain device performance (e.g., by creating a high concentration of active materials particles within a conductive matrix for battery electrodes), and simplify device processing by eliminating process steps that would be otherwise required to add the active material to a fiber mat.

Methods for Producing Carbon Fiber Mats and Polymer Fiber Mats

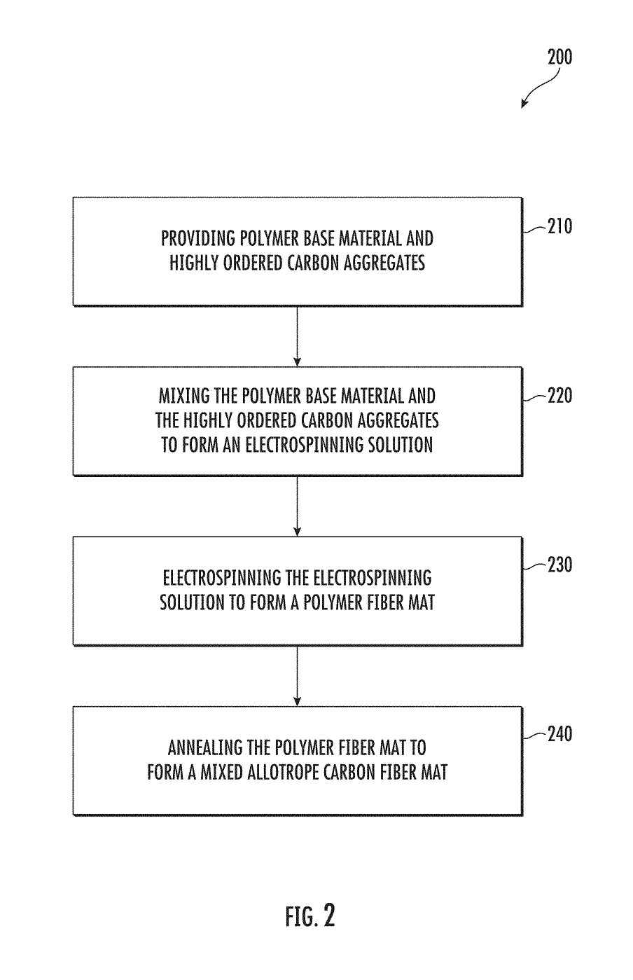

Methods for producing carbon fiber mats and polymer fiber mats will now be described. A method 200 of producing a mixed allotrope carbon fiber mat is shown in FIG. 2, in accordance with some embodiments. The method 200 includes step 210, providing a polymer base material and providing highly ordered carbon aggregates. Optionally, a plurality of active materials particles can also be provided in this step. Adding the highly ordered carbon particles and/or the active materials particles into the solution prior to electrospinning provides advantages over the conventional methods of depositing particles into a porous substrate (e.g., a metal mesh), such as improved particle dispersion uniformity and higher concentrations of particles in contact with the framework provided by the fibers. The method continues with step 220, mixing the polymer base material, the highly ordered carbon aggregates, and optionally the active materials particles together to form an electrospinning solution. Next, in step 230, the electrospinning solution is electrospun to form a polymer fiber mat. In step 240, the polymer fiber mat is annealed to carbonize the polymer fibers and form a mixed allotrope carbon fiber mat. In some embodiments, the annealing step 240 can be omitted, to form a polymer fiber mat, as described herein. In some embodiments, the base polymer provided in step 210 can be an intrinsically conductive polymer, and the annealing step 240 can be omitted, to form an intrinsically conductive polymer fiber mat, as described herein.

Battery Applications

In this section, lithium ion batteries with improved cathodes, anodes, and/or separators are described. An example of a lithium ion battery is a lithium-sulfur secondary battery. The cathodes, anodes, and/or separators described in this section contain the carbon fiber mats described herein, and/or the alternative embodiments described herein (e.g., polymer fiber mats, carbon particulate films formed from slurries including polymer binders, intrinsically conductive polymer fiber mats, etc.). For example, the substrates for the electrodes (i.e., the anodes and cathodes) can contain the carbon fiber mats described herein, and/or the alternative embodiments described herein, and/or a metal foil substrate. The electrodes themselves can also be formed of multicomponent films, which include the carbon fiber mats described herein, and/or the alternative embodiments described herein, with the active electrode materials interspersed therein. The carbon fiber mats described herein, and/or the alternative embodiments described herein, include the active materials particles and/or active materials embedded within, or mixed with, the fibers can also be used to create the battery electrodes. A separator saturated with an electrolyte (arranged between the anode and cathode electrodes) can also contain the polymer fiber mats described herein, and/or the alternative embodiments described herein, provided that the electrical conductivity is sufficiently low to enable a high electrical resistance between the electrodes. The electrolytes for the batteries described herein can contain one or more solvents, a lithium salt, and/or a redox additive. Alternatively, the separator can contain a polymeric blend, and optionally active materials particles and/or other materials particles (e.g., oxides to improve the mechanical properties of the separator and/or additives to improve battery performance).

Compared to conventional Li/S and lithium ion batteries, the materials and the structure of the cathodes, anodes, and the separators described herein, can improve the performance, manufacturability and/or stability of the batteries. For example, although not to be limited by theory, the structure of the cathode of the lithium ion batteries incorporating the carbon fiber mats described herein, can improve the capacity and longevity of Li/S batteries compared to batteries with conventional cathodes by forming high surface area with many small pockets where the polysulfides formed during charging and discharging are trapped. As a result, the migration of the polysulfides to the anode is mitigated which improves battery performance, for example, by increasing efficiency and mitigating the capacity loss per cycle. As another example, not to be limited by theory, the use of active silicon particles in the carbon fiber mats described herein incorporated into the anodes of lithium ion batteries can improve the performance and safety of the batteries compared to conventional anodes made from elemental Li. Elemental Li is highly reactive, which creates safety issues during battery operation, and can increase the cost and complexity of producing the batteries using these materials as anodes. Elemental Li electrodes in Li/S batteries also suffer from poor performance (e.g., low coulombic efficiency) and poor durability (e.g., capacity losses during cycling). As another example, not to be limited by theory, the redox additives in the electrolytes within the battery separators described herein can improve the longevity of Li/S batteries compared to batteries with conventional electrolytes by preventing the polysulfides from migrating to the anode. In different embodiments, this can be accomplished using different mechanisms including promoting the reaction of the polysulfides into Li₂S and sulfur, and tethering the polysulfides at the cathode as well as by the formation of a more stable solid electrolyte interphase at either, or both, of the anode and the cathode. In different embodiments, the sulfur and/or Li₂S can be mixed with conventional cathode materials such as nickel-manganese-cobalt (NCM) or lithium iron phosphate (LFP) to improve performance and provide an overcharge safety mechanism.

Improved cathodes, anodes, electrolytes, and components of each for lithium ion batteries are described in more detail below. The improved battery components can be used together in the same battery, or can be used in combination with conventional components to create an improved battery. For example, an improved sulfur-based cathode can be used with a conventional anode in an improved lithium ion battery. Alternatively, a conventional active cathode can be used in combination with an improved anode to create an improved lithium ion battery. Improved cathodes and anodes can be used to create a greatly improved lithium ion battery.

Cathodes for Lithium Ion Batteries

In some embodiments, the cathodes for lithium ion (e.g., Li/S) batteries contain a substrate and a cathode mixture containing a sulfur material such as elemental S and/or Li₂S. In some embodiments, the cathode mixture, which can be formed from a slurry, contains a material containing sulfur, one or more particulate carbon materials, and optionally may include a binder. In some embodiments, the cathode mixture contains a material containing sulfur, one or more particulate carbon materials, a conventional lithium ion cathode material such as NCM or LFP, and optionally may include a binder. In some embodiments, the substrate for the cathode is electrically conductive, and includes the carbon fiber mats described herein, the alternative embodiments described herein, metal foil (e.g., Ti foil, Ti alloy foil, Al foil, stainless steel foil, or other metallic foil), metallic mesh (e.g., stainless steel mesh, Al mesh), carbon paper, carbon foam, metal foam, and/or a conductive porous or solid film or coating. In some embodiments, the substrate for the cathode is electrically conductive. In some embodiments, the particulate carbon in the cathode mixture contains highly ordered carbon allotropes. In some embodiments, the particulate carbon in the cathode mixture contains doped carbon materials (e.g., carbon doped with S, N, etc.), undoped carbon materials, or combinations thereof. The particulate carbon materials contained in the cathode are described in more detail herein, in the section entitled “Carbon Particles Containing Ordered Carbon Allotropes.”

In some embodiments, the cathodes are formed from a cathode slurry, which contains a sulfur material (e.g., elemental S and/or Li₂S) and/or a conventional lithium ion cathode material, and a solvent. In some embodiments, this cathode slurry is deposited on the substrates describe above. Some examples of solvents that can be included in the cathode slurry are acetonitrile, N-Methyl-2-pyrrolidone (NMP), diglyme, dimethoxyethane (DME), septane, hexane, benzene, toluene, dichloromethane, ethanol, tetrahydrofuran (THF), and variants of the same. Some examples of conventional lithium ion cathode materials include NCM, LFP, lithium cobalt (LCO), and nickel cobalt aluminum (NCA).

In different embodiments, the cathodes can contain S, Li₂S, LiₓS_{y} (x=0-2; y=1-8), or combinations thereof. In some embodiments, the cathode slurry can contain composite materials containing S, Li₂S, LiₓS_{y}, NCM, LFP or combinations thereof either in the form of a solid or as a suspension/dissolved solution. In some cases, the Li₂S is dissolved in a solvent, and when that solvent mixture is coated and dried to produce the cathode, the Li₂S precipitates to form the Li₂S particles in the cathode. In some embodiments, the Li₂S particle sizes are from 5 nm to 100 microns. In some embodiments, the particles are contained in a liquid phase mixture containing Li₂Sₓ. In some embodiments, the cathodes contain Li₂Sₓ complexed with solvents such as acetonitrile, or any of the cathode solvents listed above. In some embodiments, the cathodes contain Li₂Sₓcomplexed with a cathode solvent (e.g., toluene) and with an active redox additive (e.g., a metallocene such as ferrocene).

In some embodiments, the cathodes contain a binder containing polyethylene oxide/polyvinylpyrrolidone (PEO/PVP), Nafion, polyvinylidene difluoride (PvDF), lithium polyacrylate (LiPAA) and combinations thereof. In some cases, the binder contains a polymer, which is carbonized using an annealing process. In some cases, the carbonized polymer forms a partially ordered carbon allotrope in the particulate carbon films.

Anodes for Lithium Ion Batteries

In some embodiments, the anodes for lithium ion (e.g., Li/S) batteries contain a substrate (e.g., the carbon fiber mats described herein, the alternative embodiments described herein, a metal foil substrate, and/or a different type of carbon substrate), and an anode mixture that can be formed from a slurry. In some embodiments, the anode mixture contains a silicon material (e.g., elemental Si, LiSi, silicon-doped CNOs), one or more particulate carbons (e.g., graphene oxide), one or more polymeric materials, and optionally one or more binders. In some embodiments, the anodes contain silicon-carbon composite materials, silicon particles coated with carbon materials. In some embodiments, the anodes contain core-shell particles containing silicon, with either silicon or carbon materials at the core. In some embodiments, the anodes contain multi-layer particles containing one or more layers of silicon and one or more layers of carbon, with either silicon or carbon materials at the core.

In some embodiments, the substrate is electrically conductive and contains the carbon fiber mats described herein, the alternative embodiments described herein, a metal foil (e.g., Ti foil, Ti alloy foil, stainless steel foil, Cu foil, Cu mesh, Cu alloy foil, or other metallic foil), and/or other conductive material.

In some embodiments, the particulate carbon in the anode mixture contains highly ordered carbon allotropes. In some embodiments, the particulate carbon in the anode mixture contains doped carbon materials (e.g., carbon doped with S, N, etc.), undoped carbon materials, or combinations thereof. The carbon materials contained in the anode are described in more detail herein, in the section entitled “Carbon Particles Containing Ordered Carbon Allotropes.”

In some embodiments, the anodes contain a slurry containing silicon particles. In some embodiments, this anode slurry is deposited on the substrates described above. The silicon particles can contain elemental silicon or lithium-silicon compounds and carbon composites thereof. Some examples of lithium-silicon compounds are Li₂₂Si₅, Li₂₂₋ₓSi_{5-y} (where x is from 0 to 21.9, and y is from 1 to 4.9), and Li₂₂₋ₓSi_{5-y-z}M_{z} (where x is from 0 to 21.9, y is from 1 to 4.9, and z is from 1 to 4.9; and M is S, Se, Sb, Sn, Ga, or As). The silicon materials can be amorphous, crystalline, semi-crystalline, nano-crystalline, or poly-crystalline in different embodiments. The silicon particles can be nanoparticles (i.e., with median diameter below 50 nm, or about 100 nm, or about 500 nm, or about 1 micron), or micron sized particles with diameters from about 500 nm to about 10 microns. As described herein, these active anodic battery materials can be incorporated (e.g., as particles) into the carbon fiber mats described herein (e.g., embedded in electrospun fibers), or into the alternative embodiments described herein.

In some embodiments, the anodes contain graphene oxide. In some embodiments, the graphene oxide provides oxygen to the materials in the anode during processing and/or operation. In other embodiments, the oxygen can be provided to the materials in the anode via another method, such as by incorporating an oxygen containing compound other than graphene oxide into the anode.

In some embodiments, the anodes contain one or more polymeric materials, such as PAN. In some cases, the polymeric materials are carbonized (e.g., through a higher than room temperature anneal in an inert gas) to form conductive carbon in the anode. In some cases, the carbonized polymer forms a partially ordered carbon allotrope in the particulate carbon films. In some cases, the polymeric material will remain a polymer in the anode, and act as a binder for particulate materials forming the anode. For example, polythiophene, PvDF-HFP, CMC, Nafion, PAN, SBR, or combinations thereof can be used as binders in the anode.

The anodes can be deposited from an anode slurry. In some cases, the anode slurry can be coated and dried on (or pressed onto, or pressed into) the anode substrate to form the anode. In some embodiments, the anode slurry contains silicon material (e.g., elemental Si, LiSi, silicon-doped CNOs), one or more particulate carbons (e.g., graphene oxide), one or more polymeric materials, one or more solvents, and optionally one or more binders. Some examples of solvents that can be used in the anode slurry are dimethylformamide (DMF), diglyme, tetraethylene glycol dimethyl ether (TEGDME), polyethylene glycol dimethyl ether (PEGDME), water, N-Methyl-2-pyrrolidone (NMP), THF, variants of the same, and other solvents compatible with the Si-based anodes used.

In some cases, carbon-based anodes including silicon use very small silicon particles (e.g., 30-50 nm), which provides improved results over conventional anodes. For example, the use of Si as the active anode material improves the electrode capacity due to the higher specific capacity of Si materials compared to carbon materials. Additionally, in some cases the use of very small Si particles provides improved results (e.g., reducing degradation caused by cycling) over Si anodes using bulk silicon or larger Si particles by improving the ability of the silicon material to expand upon intercalation during battery operation. The increased surface area to volume ratio can reduce the absolute particle lithiation expansion (i.e., the change in the particle radius upon lithiation) about 2-3× over typical larger particles (e.g., 100-150 nm). In some embodiments, the silicon is coated with a sintered carbon layer to allow for a stable electrical contact during the silicon size expansion. In some embodiments of carbon-based anodes including silicon, the carbon particles (e.g., containing MWSFs) are annealed and doped with sulfur to expand the surface area and pores. In some cases, the large particle size of the carbon particles (and the large pore size between carbon particles) in the silicon/carbon anodes provides the silicon particles with suitable expansion volumes in the electrode.

Further embodiments can include one or more of: decreasing the SiNP size to about 20 nm, increasing the binder (e.g., PAN) percentage by 50% to create a larger buffer between Si particles, and using solvents other than N-methyl-2-pyrrolidone (NMP) for the mixing solvent.

Electrolytes and Separators for Lithium Ion Batteries

The electrolyte can contain one or more solvents, a lithium salt, and optionally a redox additive. In some cases, 1, 2, 3, or 4 solvents are used in the electrolyte. Some examples of solvents that can be used in the electrolyte are non-aqueous solvents (e.g., dimethoxyethane, dioxolane, dioxane, fluorinated solvents, vinyl solvents such as fluorinated ethers, and fluorinated dioxanes). Some examples of lithium salts that can be used in the electrolyte are lithium bis(fluorosulfonyl)imide (LiFSI), bis(trifluoromethane)sulfonimide lithium salt (LiTFSI), and others. In addition to use in lithium ion batteries, the electrolytes in this section can be used for other types of next generation secondary batteries including those where Na ion, Mg ion or K ion replace Li ion.

In some embodiments, the redox additive can include one or more metallocenes. For example, the metallocene can contain a transition metal (e.g., a first d-block series transition metal, a second d-block series transition metal, and/or a third d-block series transition metal). Some examples of transition metals that can be in the redox additive are iron, ruthenium, osmium, rhodium, rhenium, iridium, and combinations thereof. In some cases, the metallocene can contain organic ligands. In some cases, these organic ligands can be electron donating and electron withdrawing group substituted N,N′ ligands. Some examples of organic ligands that can be included in the redox additives are cyclopentadienyl, pentamethylcyclopentadienyl, 2,2′-bipyridine (bpy), or combinations thereof. In different embodiments, the concentration of the redox additive in the electrolyte is from 5 mM to 0.5 M. Some examples of redox additives are bis(cyclopentadienyl)ruthenium, bis(pentamethylcyclopentadienyl)ruthenium(II), ruthenium (Bpy)3 PF6, and bis(cyclopentadienyl)osmenium.

The electrolyte can be soaked into a separator composed of a porous polymeric material. For example, polymer fiber mats with active materials can be formed (e.g., by electrospinning) from a solution containing a base polymer (e.g., polyvinylidene fluoride-hexafluoropropylene (PVDF-HFP)) and active materials and/or other materials (e.g., Nafion and/or fumed silica). Some examples of polymers used in separators are polypropylene, poly-vinylidene fluoride and polyethylene or a mixture of said polymeric materials. In some embodiments, a polymer fiber mat, as described above, has an electrolyte uptake (e.g., for a LiTFSi containing electrolyte) from 100% to 300%, or from 150% to 250%, or greater than 100%, or greater than 200%. Alternatively, the separator can be a gel or solid in the case of printed or solid-state versions of the presented concept. Alternatively, the separator can be a polymer mat (e.g., extruded, spun, woven, electrospun, or cast polymer mat) containing Nafion, LiPAA, or other polysulfide repelling agent and/or binding agent, and include a redox mediator as defined above. The binding agent, repelling agent, and/or redox mediator in this instance acts to retain the polysulfides near the cathode surface, preventing migration thereof either by acting as a chemical repulsing, charge-based repelling agent or steric hindrance to polysulfide diffusion and/or migration away from the cathode through the separator or to the anode surface. In some cases, particulates are incorporated into the separator comprised of a variety of particles (e.g., non-conductive oxides, doped oxides, nitrides, carbides) dispersed within the polymeric separator. The particles could include other redox agents such as metallocenes as discussed elsewhere in this disclosure. The particles could be of a variety of morphologies including nanoparticles, nanowires, and nanorods.

Lithium Ion Battery Performance

Lithium ion batteries with improved cathodes, anodes, and/or separators containing the carbon fiber mats described herein, and/or the alternative embodiments described herein (e.g., polymer fiber mats, carbon particulate films formed from slurries including polymer binders, intrinsically conductive polymer fiber mats, etc.), can have improved properties such as capacity, stability, charge/discharge rate, and energy density.

In some embodiments, the lithium ion battery electrodes described herein have capacity from 200 mAh to 3000 mAh, or from 400 mAh to 2000 mAh, or from 400 mAh to 1000 mAh per gram of active electrode component (e.g., sulfur or silicon). In some embodiments, the lithium ion battery electrodes described herein have improved stability, such that the capacity after 50 cycles (or 100, or 200, or 1000 cycles) is from 200 mAh to 3000 mAh, or from 400 mAh to 2000 mAh, or from 400 mAh to 1000 mAh per gram of active electrode component (e.g., sulfur or silicon). In some embodiments, the capacity of a lithium ion battery (initially, or after 50 to 1000 cycles) can be improved 2×, 3×, 4×, 5×, or greater than 5× compared to conventional lithium ion batteries. In some embodiments, the lithium ion batteries described herein have capacities that are reduced by less than 20%, or less than 10%, or less than 5%, or less than 2% between the C/10 and 1C discharge rates. In some embodiments, the lithium ion batteries described herein have specific energy of about 500 Wh/kg, and an energy density of about 500 Wh/L. In some embodiments, the energy density of the lithium ion batteries described herein is greater than 300 Wh/L, or greater than 400 Wh/L, greater than 500 Wh/L, or greater than 600 Wh/L, or greater than 800 Wh/L, or greater than 1000 Wh/L.

PEM Fuel Cells Applications

In this section, improved PEM fuel cells are described with gas diffusion layers (GDLs) containing the carbon fiber mats described herein, and/or the alternative embodiments described herein (e.g., polymer fiber mats, carbon particulate films formed from slurries including polymer binders, intrinsically conductive polymer fiber mats, etc.). GDLs typically contain backing layers, which are macroporous, and microporous layers (MPLs), which are sometimes referred to as mesoporous layers. Some key properties of the backing layers and MPLs within the GDL in PEM fuel cells that can be improved using the materials and methods described herein are the stability in the fuel cell environment, the electrical and thermal conductivity, the permeability for gases and liquids, and the mechanical properties (e.g., the elasticity under compression).

The carbon fiber mats described herein, and/or the alternative embodiments described herein (e.g., polymer fiber mats, carbon particulate films formed from slurries including polymer binders, intrinsically conductive polymer fiber mats, etc.) are highly porous and have high electrical conductivities, which are key advantages for backing layers and MPLs. Furthermore, the electrical and thermal conductivity can be tuned using different added particles (e.g., the carbon particles described herein). The porosity of the carbon fiber mats described herein, and/or the alternative embodiments described herein can also be tuned. For example, fiber diameters (which affect the mat porosity and surface area to volume ratio) within electrospun carbon fiber mats can be varied by changing the electrospinning process parameters. The carbon fiber mats and particulate films described herein can also be quite stable under both oxidizing and reducing environments, such as those found in PEM fuel cells. The mechanical properties of the carbon fiber mats described herein, and/or the alternative embodiments described herein can also be tuned, for example by changing the fiber properties, particle to binder ratios, and/or the polymer or binder species, in different embodiments.

Supercapacitor Applications

In this section, improved supercapacitors are described containing the carbon fiber mats described herein, and/or the alternative embodiments described herein (e.g., polymer fiber mats, carbon particulate films formed from slurries including polymer binders, intrinsically conductive polymer fiber mats, etc.). Supercapacitors typically contain two current collectors (e.g., metal foils), each coated with a very large surface area electrode material (e.g., activated carbon). The electrodes are typically impregnated with a liquid or viscous electrolyte, which serves as the conductive connection between the electrodes across a separator. Some key properties of the electrodes for supercapacitors that can be improved using the materials and methods described herein are electrical and thermal conductivity, high surface areas per unit volume and mass, temperature stability, and chemical stability.

The carbon fiber mats described herein, and/or the alternative embodiments described herein (e.g., polymer fiber mats, carbon particulate films formed from slurries including polymer binders, intrinsically conductive polymer fiber mats, etc.) are highly porous and have high electrical conductivities, which are key advantages for electrodes in supercapacitors. Furthermore, the electrical and thermal conductivity, and the porosity of the carbon fiber mats described herein, and/or the alternative embodiments described herein, can be tuned, as described above. The carbon fiber mats, and particulate films described herein can also be quite stable against corrosion under various chemical environments, such as those found in supercapacitors (e.g., from the constituents in the electrolytes).

### EXAMPLES

### Example 1

### Carbon Fiber Mats

In this example, carbon fiber mats were produced by electrospinning from a solution containing a PAN base polymer and a dimethylformamide (DMF) solvent. The electrospinning solution in this example contained 8 wt % PAN in DMF. The as-spun fibers were then annealed to carbonize the PAN and form the carbon fiber mat.

Thermogravimetric analysis (TGA) and differential scanning calorimetry (DSC) was performed on the electrospun PAN fiber mat (before carbonization) in an Ar atmosphere in order to determine the temperature dependence of the physical and chemical properties of the mat. The DSC experiments showed two sharp exothermic peaks, one at approximately 280° C. and one at approximately 750° C., and the TGA experiments showed that both of these peaks were accompanied by significant weight loss. The results of the TGA and the DSC experiments informed the range of possible temperatures for the carbonization anneal. In some embodiments, the carbonization anneal of a polymer fiber mat (e.g., a PAN fiber mat) is performed at temperatures greater than 300° C., or greater than 400° C., or greater than 500° C., or greater than 600° C., or greater than 700° C., or from 300° C. to 900° C., or from 300° C. to 800° C., or from 400° C. to 800° C., or from 400° C. to 800° C.

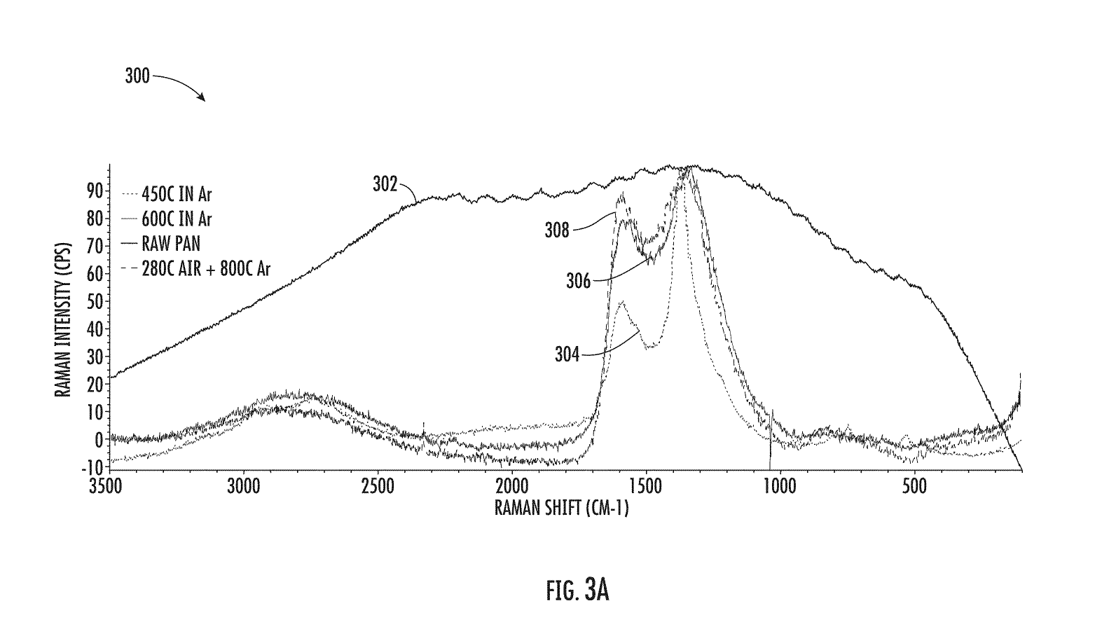

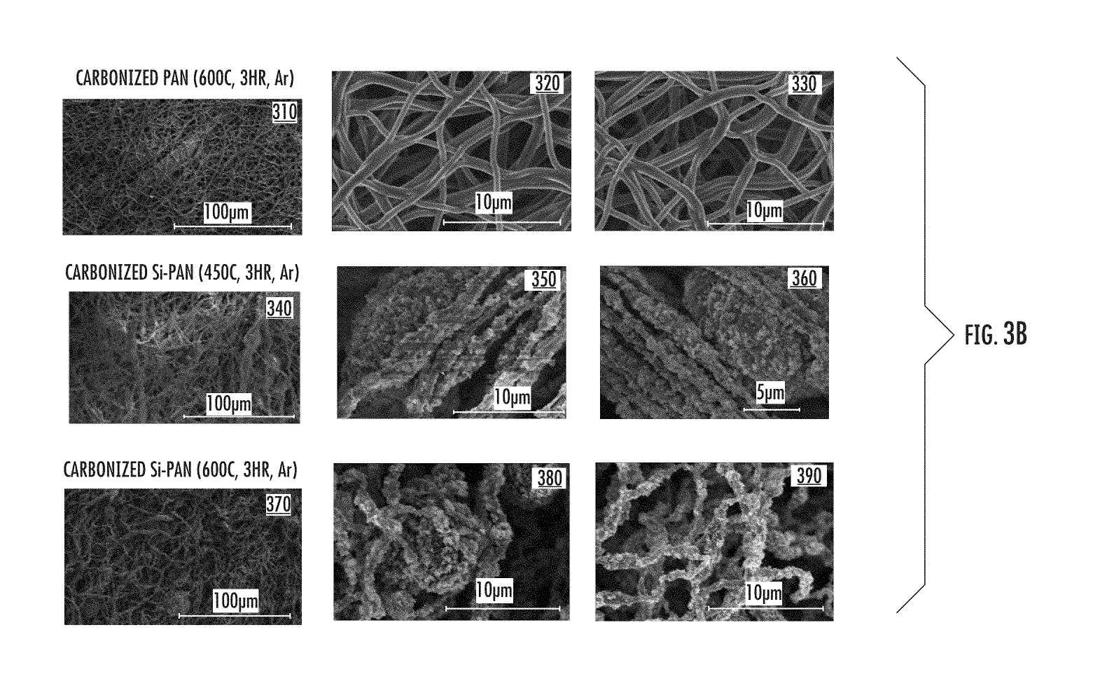

FIG. 3A shows Raman spectra 300 from the electrospun polyacrylnitrile (PAN) polymer fibers of this example before and after carbonization. The “Raw PAN” spectrum 302 was taken from an electrospun fiber mat as-spun (i.e., before carbonization annealing). The “Raw PAN” spectrum 302 showed no distinct Raman peaks due to the lack of crystallinity. The “450C in Ar” spectrum 304 was taken from an electrospun fiber mat after carbonization. The carbonization anneal process for this mat included a 5° C./sec ramp rate up to a soak temperature of 450° C. in Ar, and the soak temperature was held for approximately 2 hours. The Raman spectrum 304 showed distinct peaks indicating that the PAN fibers were carbonized into discernable carbon allotropes. The “600C in Ar” spectrum 306 was taken from an electrospun fiber mat after a carbonization process was performed, which included a 5° C./sec ramp rate up to a soak temperature of 600° C. in Ar, and the soak temperature was held for approximately 2 hours. The Raman spectrum 306 showed distinct peaks indicating that the PAN fibers were carbonized into discernable carbon allotropes. The “280C Air+800C Ar” spectrum 308 was taken from an electrospun fiber mat after a carbonization process was performed, which included a 2-step anneal process. The first step in the carbonization process for this mat included a 5° C./sec ramp rate up to a soak temperature of 280° C. in air, and the soak temperature was held for approximately 5 hours. The second step in the carbonization process for this mat included a 2° C./sec ramp rate up to a soak temperature of 800° C. in Ar, and the soak temperature was held for approximately 2 hours. The Raman spectrum 308 showed distinct peaks indicating that the PAN fibers were carbonized into discernable carbon allotropes.

The Raman spectra 304, 306 and 308 in FIG. 3A all showed distinct peaks indicating that the PAN fibers were carbonized into graphene and/or graphite carbon allotropes with some degree of order. The 2D/G intensity ratio was approximately 0.15 for the spectra 304, 306 and 308, indicating that the material is few layer graphene (FLG). The “450C in Ar” spectrum 304 has the highest ID/IG ratio compared to the “600C in Ar” spectrum 306 and the “280C Air+800C Ar” spectrum 308. Furthermore, the Raman spectra in FIG. 3A show shallow valleys between the D-mode peak and the G-mode peak, indicating that the carbonized PAN fiber contain partially ordered carbon allotropes. The minimum intensity within the valley between the D-mode peak and the G-mode peak in the “450C in Ar” spectrum 304 is approximately 60% of the G-mode peak intensity. The minimum intensities within the valleys between the D-mode peak and the G-mode peak in the “600C in Ar” spectrum 306 and the “280C Air+800C Ar” spectrum 308 are both approximately 80% of the G-mode peak intensities.

FIG. 3B shows scanning electron microscope (SEM) images 310, 320 and 330 of a carbonized PAN fiber mat from this example, which was carbonized in an Ar atmosphere at a soak temperature of 600° C. for 3 hours. Image 310 was taken at a magnification of 1000×, and images 320 and 330 were taken at magnifications of approximately 10,000×. These images show that the carbonized PAN fibers had diameters of less than 1 micron, and the mat had pore sizes on the order of 1 to 10 microns in diameter. These images also show the embedded Si nanoparticles on the fiber surface.

### Example 2

### Carbon Fiber Mats with Embedded Si Particles

In this example, carbon fiber mats with embedded Si particles were produced by electrospinning from a solution containing a PAN base polymer, Si particles and a DMF solvent. The electrospinning solution in this example contained 8 wt % PAN in DMF. The as-spun fibers were then annealed to carbonize the PAN and form the carbon fiber mat.

Thermogravimetric analysis (TGA) and differential scanning calorimetry (DSC) was performed on an electrospun PAN fiber mat containing Si particles (before carbonization) in an Ar atmosphere in order to determine the temperature dependence of the physical and chemical properties of the mat. The DSC experiments showed one sharp exothermic peak at approximately 300° C., and the TGA experiments showed that this peak was accompanied by significant weight loss. The results of the TGA and the DSC experiments informed the range of possible temperatures for the carbonization anneal of carbon fibers including embedded particles. In some embodiments, the carbonization anneal of a polymer fiber mat including embedded particles (e.g., a PAN fiber mat with Si particles and/or ordered carbon particles) is performed at temperatures greater than 300° C., or greater than 400° C., or greater than 500° C., or greater than 600° C., or greater than 700° C., or from 300° C. to 900° C., or from 300° C. to 800° C., or from 400° C. to 800° C., or from 500° C. to 700° C.

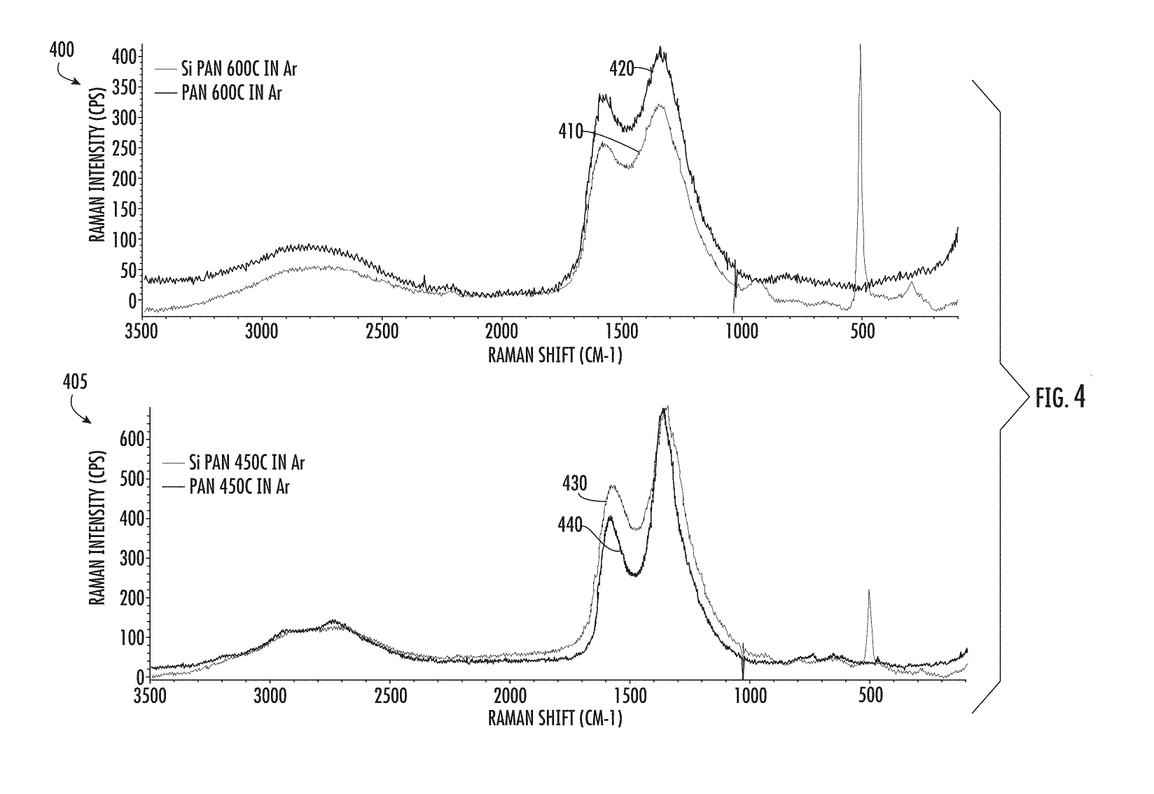

FIG. 4 shows Raman spectra 400 and 405 comparing electrospun polyacrylnitrile (PAN) polymer fibers with and without Si particles embedded therein, after carbonization. The fibers in this example were spun from a solution containing 8 wt % PAN in DMF solvent, and the weight ratio of Si particles to PAN in the solution was 1:1. The Si particles in this example had average diameters of approximately 30 nm to 50 nm. The spectra in 400 were taken from electrospun fiber mats after a carbonization process was performed, which included a 5° C./sec ramp rate up to a soak temperature of 600° C. in Ar, and the soak temperature was held for approximately 2 hours. The Raman spectrum 410 was taken from the mat containing the Si particles, and the spectrum 420 was taken from the mat containing carbonized PAN and no added Si particles. Both spectra 410 and 420 showed distinct peaks indicating that the PAN fibers were carbonized into discernable carbon allotropes. Furthermore, spectrum 410 shows a clear peak at approximately 500 cm⁻¹ indicating the presence of crystalline Si. The spectra in 405 were taken from electrospun fiber mats after a carbonization process was performed, which included a 5° C./sec ramp rate up to a soak temperature of 450° C. in Ar, and the soak temperature was held for approximately 2 hours. The Raman spectrum 430 was taken from the mat containing the Si particles, and the spectrum 440 was taken from the mat containing carbonized PAN and no added Si particles. Both spectra 430 and 440 showed distinct peaks indicating that the PAN fibers were carbonized into discernable carbon allotropes. Furthermore, spectrum 430 shows a clear peak at approximately 500 cm⁻¹ indicating the presence of crystalline Si.

The Raman spectra 410, 420, 430 and 440 in FIG. 4 all showed distinct peaks indicating that the PAN fibers were carbonized into graphene and/or graphite carbon allotropes with some degree of order. The 2D/G intensity ratio was approximately 0.15 for all of these spectra, indicating that the material is few layer graphene (FLG). The spectra 410 and 420 were similar to one another, and the spectra 430 and 440 were similar to one another indicating that the carbon allotropes in the annealed carbon fibers were not strongly influenced by the presence of the Si particles. Furthermore, the Raman spectra in FIG. 4 show shallow valleys between the D-mode peak and the G-mode peak (e.g., with minimum intensities from 60% to greater than 80% of the G-mode peak intensity), indicating that the carbonized PAN fiber contain partially ordered carbon allotropes.

Returning to FIG. 3B, scanning electron microscope (SEM) images 340, 350 and 360 are of a carbonized PAN fiber mat including embedded Si particles, carbonized in an Ar atmosphere at a soak temperature of 450° C. for 3 hours. FIG. 3B also shows scanning electron microscope (SEM) images 370, 380 and 390 of a carbonized PAN fiber mat including embedded Si particles, carbonized in an Ar atmosphere at a soak temperature of 600° C. for 3 hours. Images 340 and 370 were taken at a magnification of 1000×, and images 350, 360, 380 and 390 were taken at magnifications of approximately 10,000×. These images show that the carbonized PAN fibers with embedded Si particles had rougher surfaces than the carbonized PAN fibers without embedded particles. The rough surfaces are indicative of the large surface areas of the carbon fiber mats with embedded particles. In some cases, the surface areas of the carbon fiber mats with embedded particles are larger than those of carbon fiber mats without embedded particles. The fibers in the mats also had diameters of less than 1 micron, and the mats had pore sizes on the order of 1 to 10 microns in diameter.

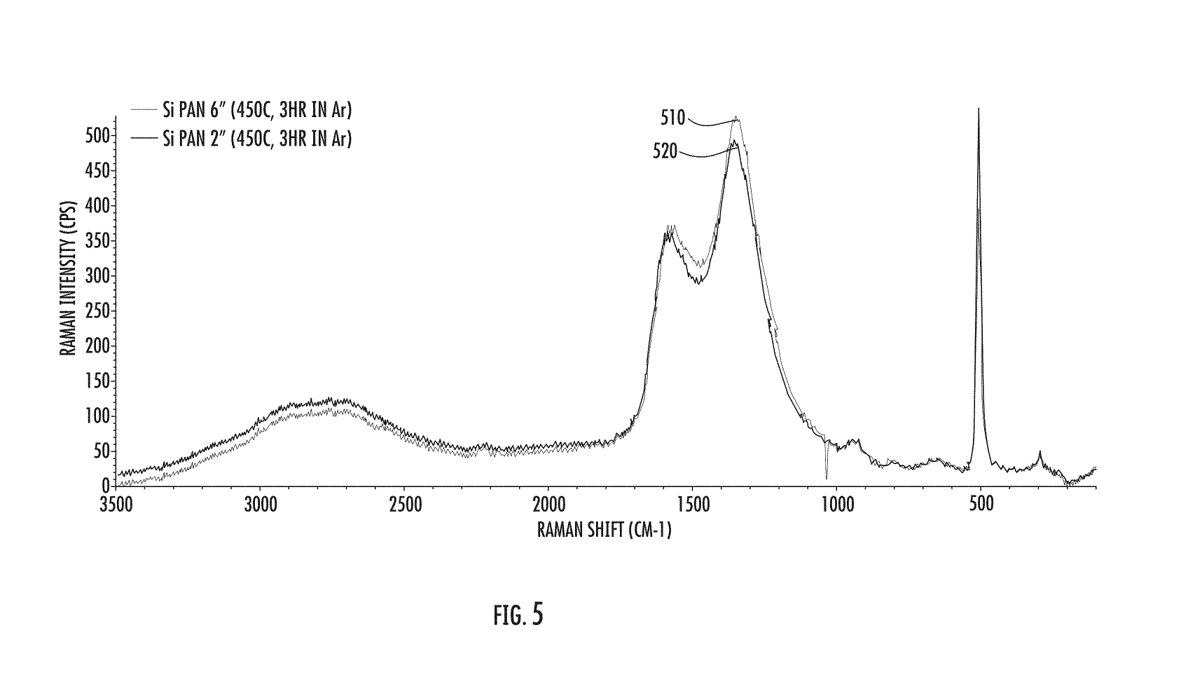

FIG. 5 shows Raman spectra 510 and 520 comparing electrospun polyacrylnitrile (PAN) polymer fibers with embedded Si particles after carbonization, with two different needle-to-collector distances during the electrospinning process. The fibers in this example were spun from a solution containing 8 wt % PAN in DMF solvent, and the weight ratio of Si particles to PAN in the solution was 1:1. The Si particles in this example had average diameters of approximately 30 nm to 50 nm. Spectrum 510 was taken from a carbon fiber mat with embedded Si particles that was spun with a needle-to-collector distance of 6″, and spectrum 520 was taken from a carbon fiber mat with embedded Si particles that was spun with a needle-to-collector distance of 2″. The spectra 510 and 520 were similar to one another, indicating that there is no appreciable difference between the carbon allotropes in the carbon fiber mats with different needle-to-collector distances during electrospinning. The morphologies of the carbonized carbon fibers mats with different needle-to-collector distances during electrospinning were also very similar (e.g., the fiber diameters and mat pore sizes were similar).

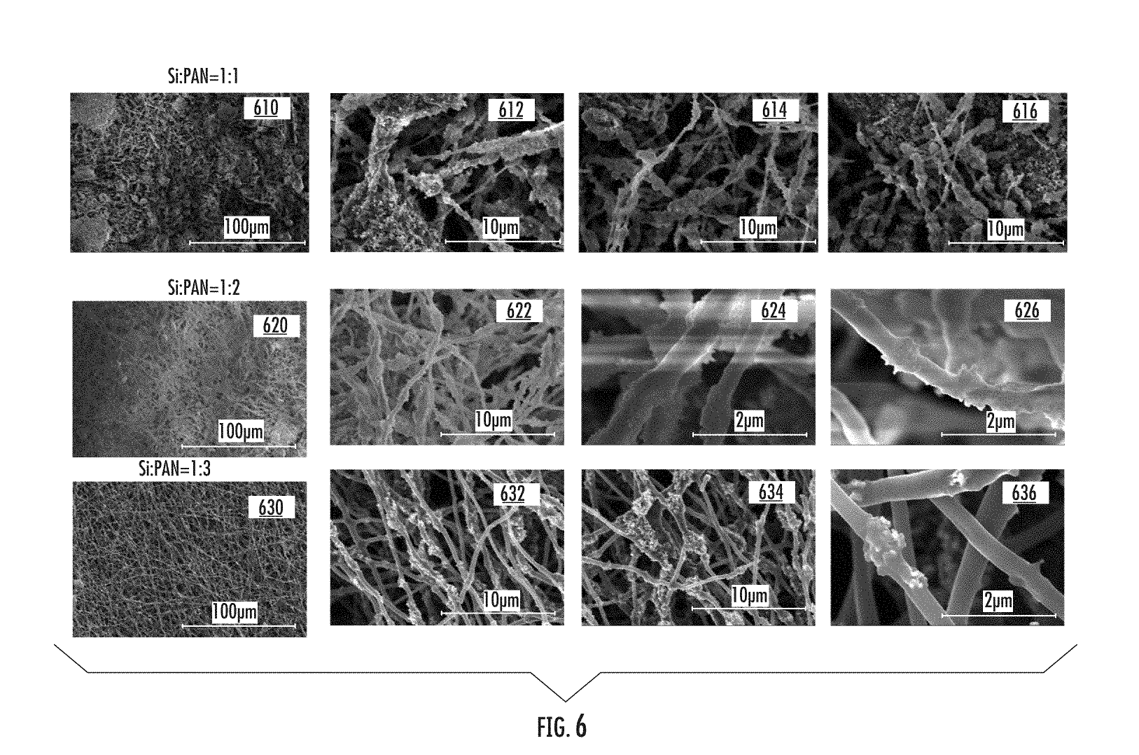

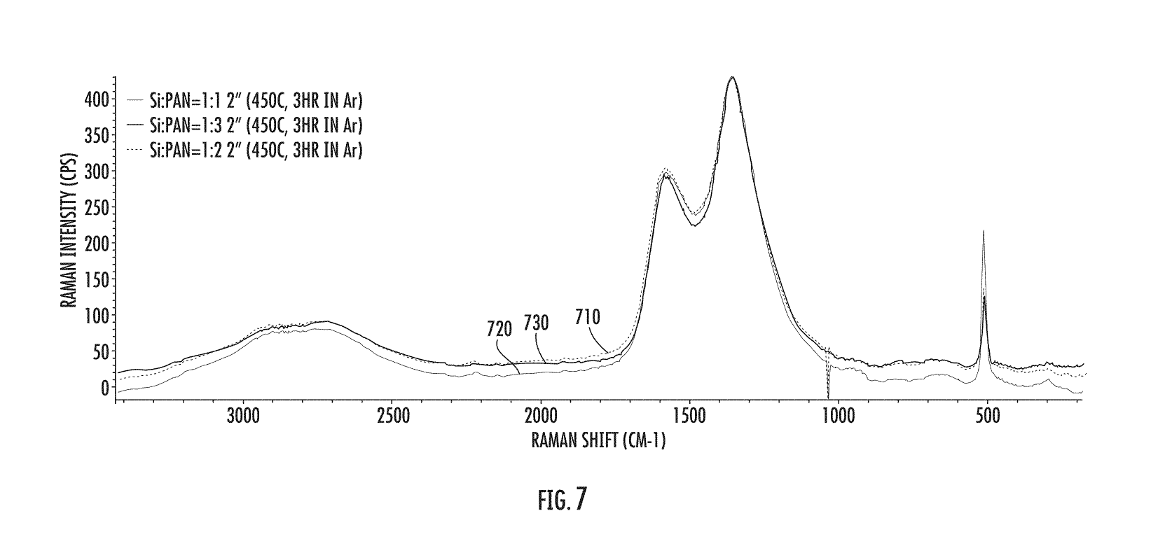

FIG. 6 shows SEM images comparing electrospun PAN polymer fibers with embedded Si particles after carbonization, with different weight ratios of Si particles to PAN in the electrospinning solutions. The fibers in this example were spun from a solution containing 8 wt % PAN in DMF solvent, and the Si particles had average diameters of approximately 30 nm to 50 nm. Images 610-616 had weight ratio of Si particles to PAN in the solution of approximately 1:1. Images 620-626 had weight ratio of Si particles to PAN in the solution of approximately 1:2. Images 630-636 had weight ratio of Si particles to PAN in the solution of approximately 1:3. The images in FIG. 6 show that the surfaces of the fibers with the higher weight fraction of embedded Si particles were rougher than the surfaces of the fibers with the lower weight fraction of embedded Si particles. The images in FIG. 6 also show that the variation of weight fraction of Si particles to PAN does not appreciably change the average fiber diameter in the mats, or the average pore size of the mats.

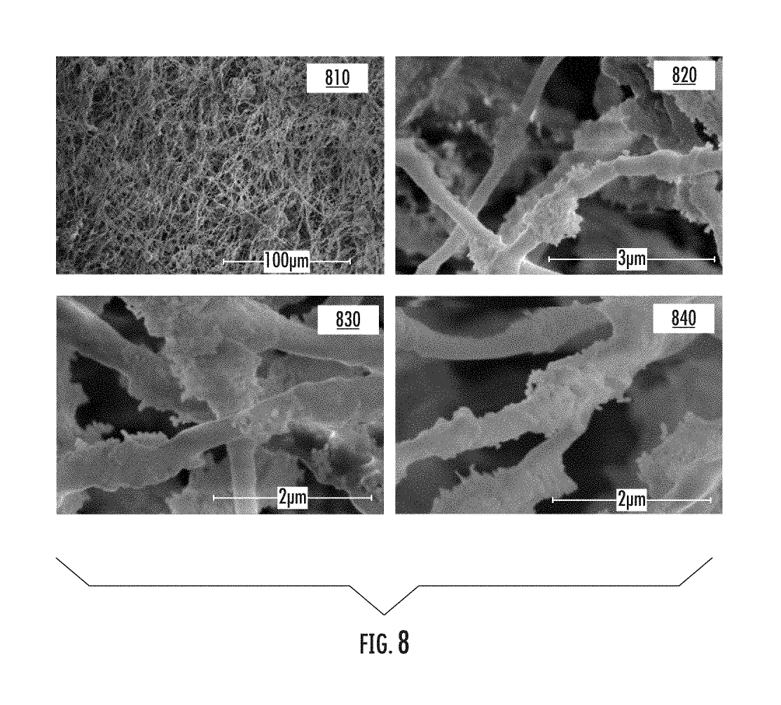

FIG. 7 shows Raman spectra 710, 720 and 730 comparing electrospun PAN polymer fibers with embedded Si particles after carbonization, with three different weight ratios of Si particles to PAN in the electrospinning solutions. The fibers in this example were spun from a solution containing 8 wt % PAN in DMF solvent, with 2″ needle-to-collector distance, and were carbonized using a soak temperature of 450° C. in Ar for approximately 3 hours. The Si particles in this example had average diameters of approximately 30 nm to 50 nm. Spectrum 710 was taken from a carbon fiber mat spun using a weight ratio of Si particles to PAN in the solution of approximately 1:1. Spectrum 720 was taken from a carbon fiber mat spun using a weight ratio of Si particles to PAN in the solution of approximately 1:2. Spectrum 730 was taken from a carbon fiber mat spun using a weight ratio of Si particles to PAN in the solution of approximately 1:3. The spectra 710, 720 and 730 were similar to one another, indicating that there is no appreciable difference between the carbon allotropes in the carbon fiber mats with different weight ratios of Si particles to PAN in the electrospinning solutions.

### Example 3

### Carbon Fiber Mats with Embedded Si Particles and Graphene Particles

In this example, carbon fiber mats with embedded Si particles and carbon particles were produced by electrospinning from a solution containing a PAN base polymer, Si particles, carbon particles and a DMF solvent. The electrospinning solution in this example contained 8 wt % PAN in DMF. The as-spun fibers were then annealed to carbonize the PAN and form the carbon fiber mat. The Si particles in this example had average diameters of approximately 30 nm to 50 nm.

FIG. 8 shows scanning electron microscope (SEM) images 810, 820, 830 and 840 of a carbonized PAN fiber mat including embedded Si particles and carbon particles, carbonized in an Ar atmosphere at a soak temperature of 450° C. for 3 hours. Image 810 was taken at a magnification of 1000×, image 820 was taken at a magnification of 35,000×, and images 830 and 840 were taken at magnifications of approximately 50,000×.

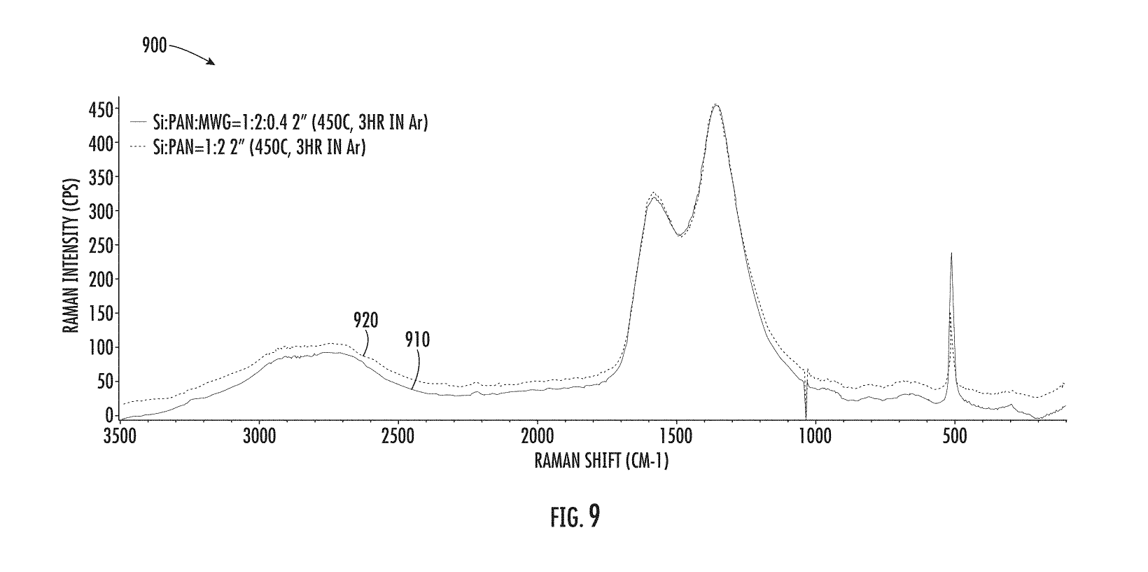

FIG. 9 shows Raman spectra 900 comparing electrospun PAN polymer fibers with embedded Si particles after carbonization to fibers with embedded Si particles and carbon particles after carbonization. Spectrum 920 was taken from a carbon fiber mat spun using a weight ratio of Si particles to PAN in the solution of approximately 1:2. Spectrum 910 was taken from a carbon fiber mat spun using a weight ratio of Si particles to PAN to carbon particles in the solution of approximately 1:2:0.4. The spectra 910 and 920 were similar to one another, indicating that there is no appreciable difference between the carbon allotropes in the carbon fiber mats with and without carbon particles.

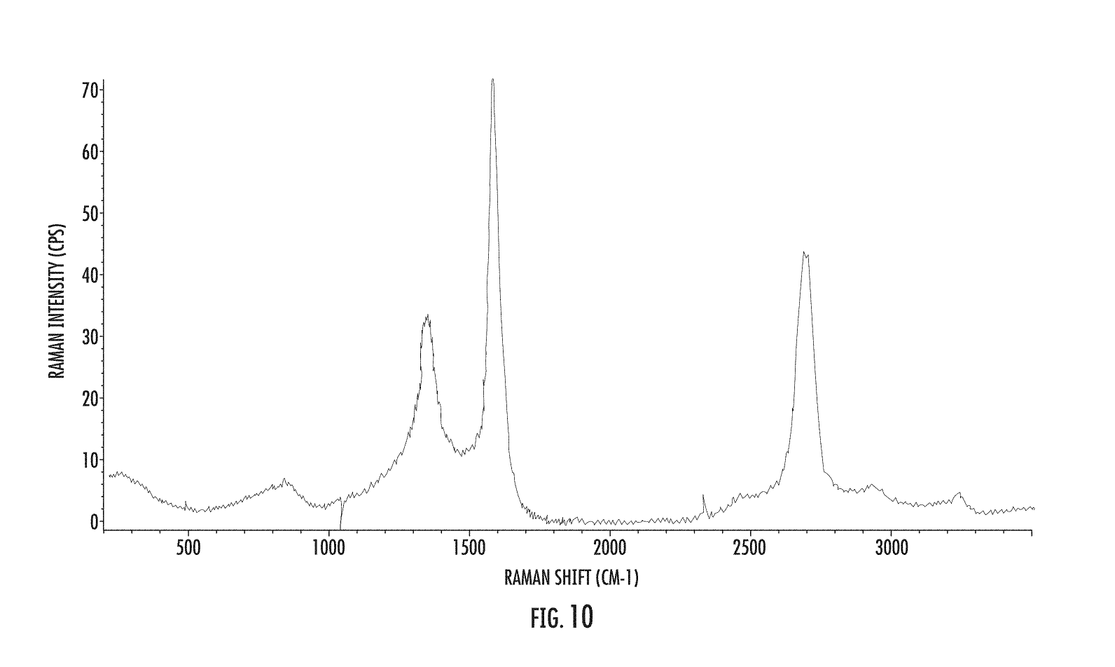

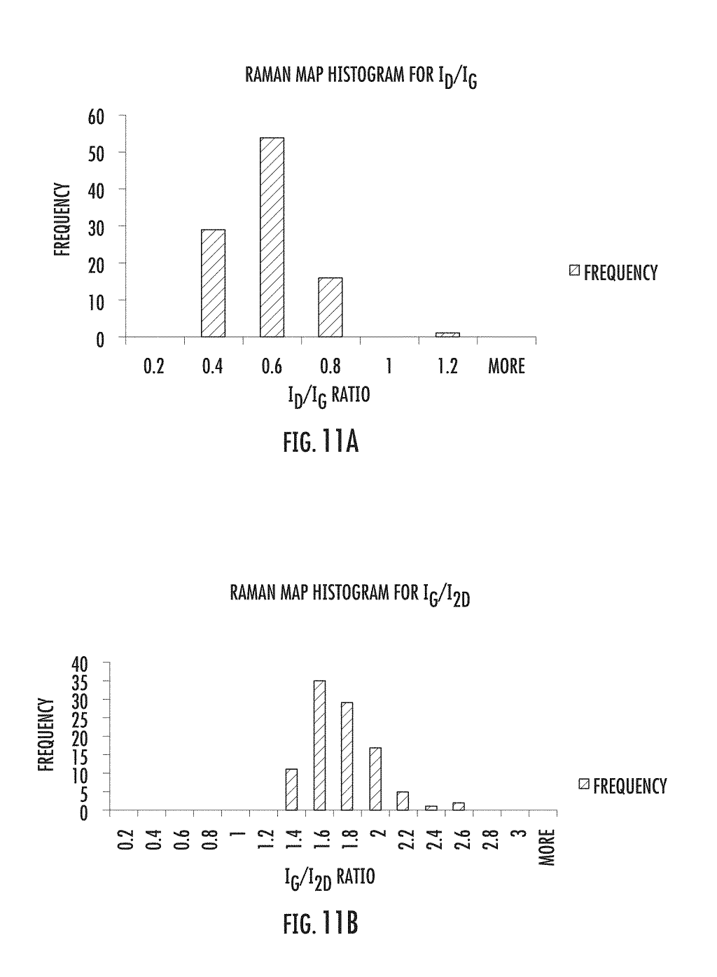

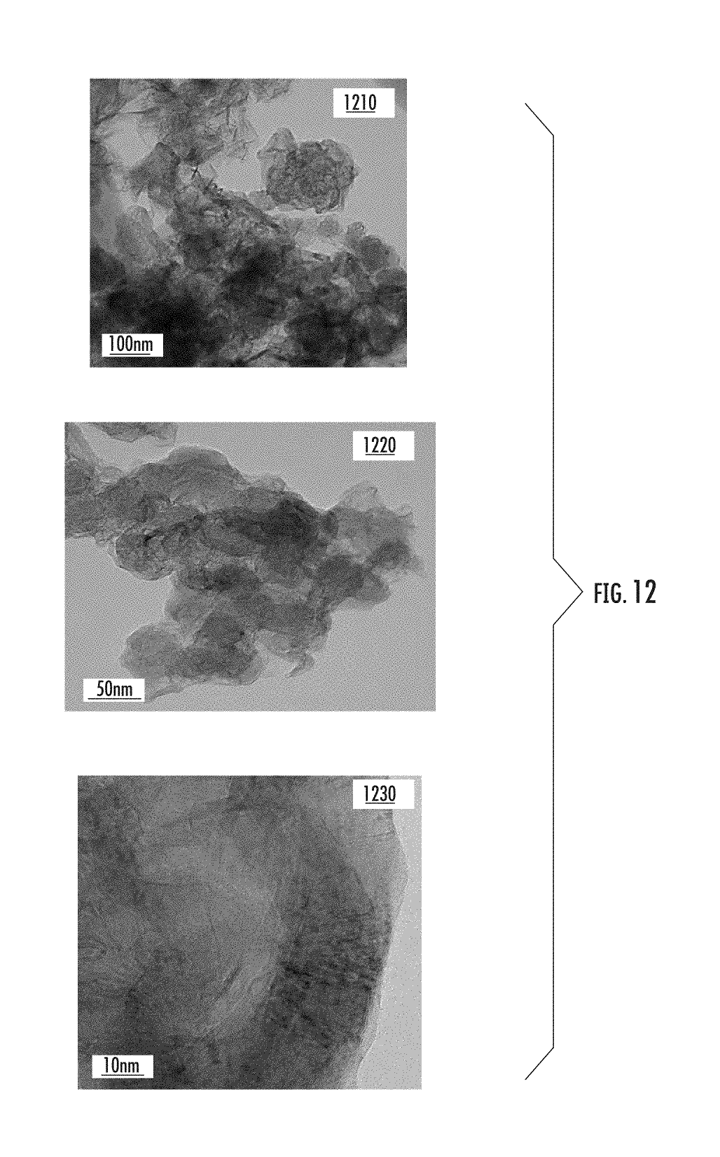

The carbon particles used in this example contained ordered graphene carbon allotropes. FIG. 10 is a Raman spectrum of the carbon particles in this Example. This Raman spectrum showed the typical bands of the sp2 bonded carbon in multi-layered graphene (i.e., the D band was at 1321 cm⁻¹, the G band at 1570 cm⁻¹ and the overtone 2D band at 2640 cm⁻¹). FIG. 11A shows a histogram for the I_{D}/I_{G} ratio for a 100-point Raman map of the carbon particles from this Example. The I_{D}/I_{G} for these materials was from approximately 0.2 to 0.8. FIG. 11B shows a histogram for I_{G}/I_{2D} ratio for a 100-point Raman map of the carbon particles from this Example. The I_{G}/I_{2D} for these materials was from approximately 1.2 to 2.2. These peak ratios indicate that the majority of the graphene in the carbon particles in this Example have approximately 3-6 layers. FIG. 12 shows transmission electron microscope (TEM) images 1210, 1220 and 1230 of the carbon particles from this Example, and show that the carbon particles had 3D structures in some cases. The crystalline planes within the carbon particles are also clearly visible in image 1230.

### Example 4

### Polymer Fiber Mats with Other Materials

In this example, polymer fiber mats with active materials were produced by electrospinning from a solution containing a PVDF-HFP base polymer and Nafion and/or fumed silica. The electrospinning solution in this example contained 10 wt % PVDF-HFP in a DMF: acetone (in a ratio of 70:30 by weight) solvent mixture. In this Example, the as-spun fibers formed the polymer fiber mats with other materials, and no carbonization anneal was performed. The polymer fiber mats with other materials in this Example can be used in various applications including, for example, as polymer fiber separators in secondary batteries.

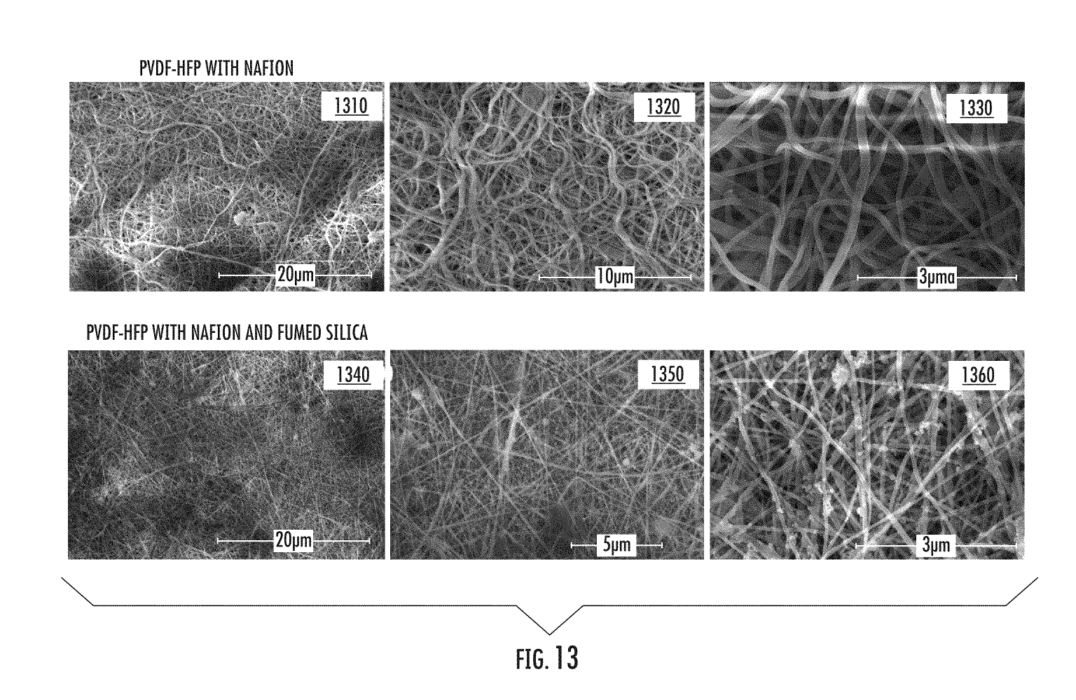

FIG. 13 shows scanning electron microscope (SEM) images 1310, 1320, and 1330 of a PVDF-HFP fiber mat including Nafion. FIG. 13 also shows scanning electron microscope (SEM) images 1340, 1350, and 1360 of a PVDF-HFP fiber mat including Nafion and fumed silica. Images 1310 and 1340 were taken at a magnification of approximately 5000×, and images 1320, 1330, 1350 and 1360 were taken at magnifications of approximately 10,000×. These images show that uniform polymer fiber mats with other materials were produced with fiber diameters less than 1 micron, and fiber mat pore sizes on the order of 100 nanometers to 10 microns.

### Example 5

### Intrinsically Conductive Polymer Fiber Mats

In this example, intrinsically conductive polymer fiber mats were produced by electrospinning from a solution containing a polythiophene (or poly-3-hexyl-thiophene, or P3HT) and a polymer of ethylene oxide (PEO) base, and optionally silicon and/or carbon particles. The electrospinning solution in this example contained 1.3-2.6 wt % P3HT, and 1.3-2.6 wt % PEO in chloroform (CHCl₃) solvent. In some cases, the solution also contained 1.3 wt % silicon active materials particles with average diameters of approximately 30 nm to 50 nm. The electrospinning conditions included from 2″ to 7.1″ needle-to-collector distance, and from 12.5 kV to 19.5 kV needle to collector bias potential. In this Example, the as-spun fibers formed the intrinsically conductive co-polymer fiber mats (optionally with embedded silicon and/or carbon particles), and no carbonization anneal was performed. The intrinsically conductive polymer fiber mats in this Example can be used in various applications including, for example, as current collectors, electrode substrates, and electrodes in secondary batteries.

In some processes in this Example, the as-spun fibers were etched using isopropyl alcohol (IPA) at 75° C. to remove the PEO in the co-polymer. In some cases, after spinning, and either before or after etching, the intrinsically conductive polymers in this Example were doped with I₂.

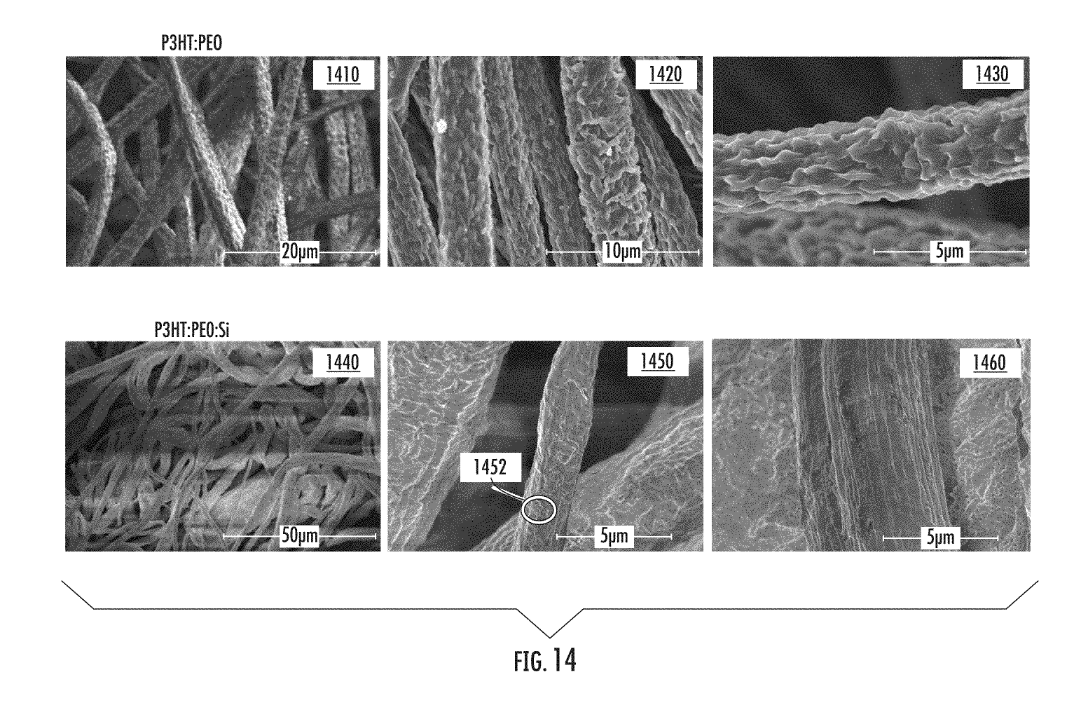

FIG. 14 shows example scanning electron microscope (SEM) images of intrinsically conductive polymer fiber mats of this Example. Images 1410, 1420 and 1430 in FIG. 14 are intrinsically conductive co-polymer fiber mats, with no particles embedded. These fibers were spun with 2.6 wt % P3HT, and 1.3 wt % PEO in chloroform (CHCl₃) solvent, with a needle-to-collector distance of 7.1″, a bias of 12.5 kV, and a flow of 3 mL/hr. Images 1440, 1450 and 1460 in FIG. 14 show intrinsically conductive co-polymer fiber mats with embedded silicon particles. These fibers were spun with 2.6 wt % P3HT, 2.6 wt % PEO, and 1.3 wt % of silicon particles, in chloroform (CHCl₃) solvent, with a needle-to-collector distance of 7.1″, a bias of 12.5 kV, and a flow of 3 mL/hr. Silicon particles are visible on the surface of the fibers, such as in the circled region 1452. The intrinsically conductive polymer fiber mats in this Example were produced with average fiber diameters from about 1 micron to about 5 microns.

### Example 6

### Particulate Carbon-based Secondary Battery Anodes

In this example, anodes for secondary batteries (e.g., Li/S, or Li-ion batteries) were produced that contained a mixture of electrically conductive carbon particles and silicon particle active materials. The anodes in this example were produced from slurries containing carbon particles, silicon particles, a polymer, and optionally graphene oxide particles. The slurries were coated on conductive substrates (e.g., copper foils), and then the coated films were annealed to carbonize the polymer in the films.

The carbon particles used in the anodes in this example contained highly ordered carbon allotropes, such as graphene and multi-walled spherical fullerenes (MWSFs). The carbon particles were activated to produce a good surface (pore size) to seed lithium ions during battery cycling. This was achieved by ball milling the carbon particles (e.g., particles containing MWSFs) from about 40 microns to about 1 micron, and steaming the surface of the MWSFs to expand the surface graphene. The steaming was performed at 180° C. in an autoclave for 12 hours. Optionally, the carbon particles were annealed and doped with sulfur to further expand the surface area and pore volumes.

A first set of silicon-based anodes in this Example were produced from a mixture of the carbon particles, Si particles with average diameters from 30-50 nm, PAN, 1% graphene oxide (GO), and a DMF solvent. The carbon particles, Si particles and PAN are mixed in various ratios, such as 19:60:20, 29:40:30, and variations thereof. This mixture was applied as a slurry to a copper substrate, and then dried and annealed at 450° C. in Ar for 2 hours to carbonize the PAN and form the fixed anode structure. Half-cell test samples of the produced anodes had capacities from 1000 to 3000 mAhr per gram of the total anode material. These results are approximately a 10× improvement over control samples with anodes produced using similar materials and configurations, which use typical conductive carbon and graphite particles rather than the improved carbon particles described herein. Full batteries with the silicon-based anodes from this Example, sulfur-based cathodes and an electrolyte were also produced. Optionally, a low current first cycle was used to properly fix the solid electrolyte interphase (SEI) layer in these full batteries, before increasing the current in subsequent cycles.

A second set of silicon-based anodes in this Example were produced from a mixture of the sulfur doped carbon particles, Si particles with average diameters from 30-50 nm, PAN, 1% graphene oxide (GO) and a DMF solvent. The carbon particles, Si particles, and PAN are mixed in various ratios, such as 19:60:20, 29:40:30, and variations thereof. This mixture was applied as a slurry to a copper substrate, and then dried and annealed at 450° C. in Ar for 2 hours to carbonize the PAN and form the fixed anode structure. After annealing, the carbonized PAN was converted into a carbon-based material containing partially ordered carbon allotropes. Half-cell test samples of the produced anodes had capacities of approximately 1000 to 3000 mAhr per gram of the total anode material. Full batteries with the silicon-based anodes from this Example, sulfur-based cathodes and an electrolyte were also produced.

### Example 7

### Particulate Carbon-based Secondary Battery Cathodes

In this example, cathodes for secondary batteries (e.g., Li/S, or Li-ion batteries) were produced that contained a mixture of electrically conductive carbon particles and sulfur active materials. The cathodes in this example were produced using the carbon particles described in Example 6, or using graphene oxide particles. In some cases, sulfur was then melt diffused into the carbon particles and/or graphene oxide particles to create sulfur-based cathodes with a nanostructured matrix of a carbon-based material infused with sulfur-based active materials. In other cases, sulfur particles were mixed with the carbon particles and annealed to form carbon-sulfur particles.

A first set of sulfur-based cathodes in this Example were fabricated using high surface area graphene oxide. In this process, graphene oxide particles were produced from the particles described in Example 6 using the Hummer method. Sulfur was then melt diffused into the pores of the graphene oxide and annealed at 135° C. in Ar for 1 hour. The sulfur infused particles were then mixed with conductive carbon, PEO, PVP and/or Nafion and a solvent to form a slurry. Various ratios of the carbon and sulfur particles to the conductive carbon to the polymeric material were used, such as 90:5:5, 50:45:5, 75:20:10, and variations thereof. The slurry was then coated onto a substrate and dried overnight at 60° C. to form a cathode.

In other processes, the carbon particles described in Example 6 were mixed with sulfur particles in a ratio of 1:3 (carbon particles to sulfur particles by weight). This mixture was then annealed in an autoclave at 525° C. for approximately 12 hours to form sulfur infused (i.e., doped) carbon particles.

The sulfur doped materials in this Example can be used for various applications including as an additive for battery cathodes, anodes (especially Si), fuel cells, supercapacitors or other high surface area energy related applications.

In yet other approaches, the basic Li/S battery chemistry can be changed to reduce the polysulfide shuttle in the electrolyte during battery charging and discharging. These changes in basic battery chemistry include methods such as increasing the molar concentration of the electrolyte by 3×, using gel polymer or solid state type electrolytes, or using redox mediators.

The above approaches for carbon-based cathodes can be used independently or in combination with each other.

### Example 8

### Conductive Carbon Paper

In this example, conductive carbon papers were produced that contained a mixture of electrically conductive carbon particles. The papers in this example were produced using the particles described in Example 6, and/or using graphene oxide particles described in Example 7. The carbon papers in this Example can be used in various applications including, for example, as current collectors for sulfur-based cathodes secondary batteries.

The carbon papers in this example were made by mixing the graphene oxide particles, the carbon particles, and PVDF, e.g., in a 4:1 ratio of carbon particles to PVDF, in an NMP solvent. This mixture was then coated onto a substrate and dried. Alternatively, the slurry binder PVDF can be replaced with PVP and/or polyethylene oxide (POE) polymer binders.

The resulting carbon papers had very high porosity, and therefore could be loaded with 2-3× more active materials (e.g., sulfur-based cathode active materials) than conventional electrodes, while fitting in the same volume of the battery.

Reference has been made to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A mixed allotrope particulate carbon film, comprising:
a partially ordered carbon material comprising a carbonized polymer material;
a plurality of highly ordered carbon aggregates; and
a plurality of active materials particles, wherein:
the plurality of highly ordered carbon aggregates comprises multi-walled spherical fullerenes.

2. The mixed allotrope particulate carbon film of claim 1, wherein:
a Raman spectrum of the partially ordered carbon material, using 532 nm incident light, comprises: a D-mode peak; a G-mode peak; and a D/G intensity ratio from 1.2 to 1.7; and a shallow valley between the D-mode peak and G-mode peak.

3. The mixed allotrope particulate carbon film of claim 1, wherein:
a Raman spectrum of the highly ordered carbon aggregates comprising multi-walled spherical fullerenes, using 532 nm incident light, comprises: a D-mode peak and a G-mode peak, and a D/G intensity ratio from 0.9 to 1.1.

4. The mixed allotrope particulate carbon film of claim 1, wherein
a surface area of the plurality of highly ordered carbon aggregates is from 50 m²/g to 2000 m²/g, when measured via a Brunauer-Emmett-Teller (BET) method with nitrogen as the adsorbate.

5. The mixed allotrope particulate carbon film of claim 1, wherein:
the plurality of active materials particles comprise silicon, and the active materials particles comprising silicon are embedded in the partially ordered carbon material; wherein
the average particle size of the active materials particles comprising silicon is from 10 nm to 2 microns.

6. The mixed allotrope particulate carbon film of claim 1, wherein the highly ordered carbon aggregates further comprise multi-walled spherical fullerenes doped with sulfur.

7. A lithium-ion secondary battery comprising the mixed allotrope particulate carbon film of claim 1.

8. A mixed allotrope carbon fiber mat, comprising:
partially ordered carbon fibers comprising carbonized polymer fibers;
a plurality of highly ordered carbon aggregates; and
a plurality of active materials particles, wherein:
the plurality of highly ordered carbon aggregates comprises a plurality of carbon nanoparticles, each carbon nanoparticle comprising graphene with up to 15 layers, with no seed particles;
a ratio of carbon to other elements, except hydrogen, in the highly ordered carbon aggregates is greater than 99%;
a median size of the highly ordered carbon aggregates is from 1 to 50 microns;
a surface area of the highly ordered carbon aggregates is from 50 m²/g to 2000 m²/g, when measured via a Brunauer-Emmett-Teller (BET) method with nitrogen as the adsorbate; and
the highly ordered carbon aggregates, when compressed, have an electrical conductivity from 500 S/m to 20,000 S/m.

9. The mixed allotrope carbon fiber mat of claim 8, wherein:
a Raman spectrum of the partially ordered carbon fibers, using 532 nm incident light, comprises: a D-mode peak; a G-mode peak; and a D/G intensity ratio from 1.2 to 1.7; and a shallow valley between the D-mode peak and G-mode peak.

10. The mixed allotrope carbon fiber mat of claim 8, wherein:
a Raman spectrum of the plurality of highly ordered carbon aggregates comprising graphene, using 532 nm incident light, comprises: a 2D-mode peak; a G-mode peak; and a 2D/G intensity ratio greater than 0.5.

11. The mixed allotrope carbon fiber mat of claim 8, wherein:
the plurality of active materials particles comprise silicon, and the active materials particles comprising silicon are embedded in the partially ordered carbon fibers; wherein
the average particle size of the active materials particles comprising silicon is from 10 nm to 2 microns.

12. The mixed allotrope carbon fiber mat of claim 11, wherein:
a Raman spectrum of the mixed allotrope carbon fiber mat, using 532 nm incident light, comprises: a D-mode peak; a G-mode peak; a D/G intensity ratio from 1.2 to 1.7; and a peak at about 500 cm⁻¹.

13. A lithium-ion secondary battery comprising the mixed allotrope carbon fiber mat of claim 8.

14. A mixed allotrope carbon fiber mat, comprising:
partially ordered carbon fibers comprising carbonized polymer fibers;
a plurality of highly ordered carbon aggregates; and
a plurality of active materials particles, wherein:
the plurality of highly ordered carbon aggregates comprises a plurality of carbon nanoparticles, each carbon nanoparticle comprising graphene with up to 15 layers, with no seed particles;
a ratio of carbon to other elements, except hydrogen, in the highly ordered carbon aggregates is greater than 99%;
a median size of the highly ordered carbon aggregates is from 1 to 50 microns;
a surface area of the highly ordered carbon aggregates is from 50 m²/g to 2000 m²/g, when measured via a Brunauer-Emmett-Teller (BET) method with nitrogen as the adsorbate;
the highly ordered carbon aggregates, when compressed, have an electrical conductivity from 500 S/m to 20,000 S/m; and
the active materials particles comprise silicon.

15. The mixed allotrope carbon fiber mat of claim 14, wherein:
a Raman spectrum of the partially ordered carbon fibers, using 532 nm incident light, comprises: a D-mode peak; a G-mode peak; and a D/G intensity ratio from 1.2 to 1.7; and a shallow valley between the D-mode peak and G-mode peak.

16. The mixed allotrope carbon fiber mat of claim 14, wherein:
a Raman spectrum of the highly ordered carbon aggregates comprising graphene, using 532 nm incident light, comprises: a 2D-mode peak; a G-mode peak; and a 2D/G intensity ratio greater than 0.5.

17. The mixed allotrope carbon fiber mat of claim 14, wherein:
the average particle size of the active materials particles comprising silicon is from 10 nm to 2 microns.

18. The mixed allotrope carbon fiber mat of claim 17, wherein:
a Raman spectrum of the mixed allotrope carbon fiber mat, using 532 nm incident light, comprises: a D-mode peak; a G-mode peak; a D/G intensity ratio from 1.2 to 1.7; and a peak at about 500 cm¹.

19. A lithium-ion secondary battery comprising the mixed allotrope carbon fiber mat of claim 14.
